(19) United States
(12) Patent Application Publication
(10) Pub. No.: US 2025/0166098 A1
(43) Pub. Date: May 22, 2025

(54) DYNAMIC OPERATION OF BEVERAGE ROBOTS AND ASSOCIATED SYSTEMS AND METHODS

(71) Applicant: BOTRISTA, INC., San Francisco, CA (US)

(72) Inventors: Wu-Chou KUO, San Francisco, CA (US); Yu-Wei CHEN, New Taipei City (TW); Alexander Milton FRIEDMAN, San Francisco, CA (US)

(21) Appl. No.: 18/935,356

(22) Filed: Nov. 1, 2024

Related U.S. Application Data
(60) Provisional application No. 63/600,955, filed on Nov. 20, 2023.

(51) Int. Cl. G06Q 50/12; G06Q 10/0631; G06Q 30/0601; G07F 13/06

(52) U.S. Cl. CPC G06Q 50/12; G06Q 10/063114; G06Q 10/06316; G06Q 30/0633; G07F 13/065

(57) ABSTRACT

A mesh network of food and/or beverage robots, and associated systems and methods, are disclosed herein. For example, a method of operating a beverage robot at a vending location can include receiving an order requesting a beverage and determining the geographic location information associated with the order. The method can also include determining an estimated time of arrival of the user picking up the order and completing the order within a time threshold of the estimated time of arrival. The method can also include determining a delivery time for a delivery person to deliver the beverage from the vending location to a delivery location and adjusting at least one ingredient in the recipe of the beverage based on the delivery time.

### CROSS-REFERENCE TO RELATED APPLICATION

This application is a non-provisional of and claims priority to U.S. Provisional Application No. 63/600,955, filed on Nov. 20, 2023, entitled “FOOD STERILIZATION SYSTEM, INGREDIENT MIXING SYSTEM, MULTIPURPOSE BLENDING SYSTEM, BEVERAGE MENU GENERATOR, CONTAINER SQUEEZING DEVICES, FRYER APPARATUS, COFFEE PREPARATION APPARATUS, FLUID DISPENSING SYSTEM, AND RELATED CLOUD SYSTEM,” which is hereby incorporated by reference in its entirety for all purposes.

### TECHNICAL FIELD

The present technology is generally directed to operating robots and more specifically to systems and methods for operating beverage and/or food robots to prepare individual items in an order.

### BACKGROUND

Freshly made beverages are typically more desirable to consumers than factory-produced, canned, or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. The fresh preparation, however, typically requires the time and attention of vendor personnel, which can slow down order production, causing customer dissatisfaction, reducing the volume of orders vendors can produce, and/or increasing the costs per order. To meet these challenges, vendors have increasingly automated portions, or all, of the production of beverages.

Automation brings about another set of challenges. For example, automating beverage productions requires that vendors be able to maintain, diagnose, and fix the automation systems. Additionally, vendors must be able to track and monitor ingredients and ingredient inventory for the automated systems to avoid preparing contaminated drinks. Still further, vendors must be able to track orders through the automated system to ensure customer satisfaction with the timing, resulting orders, and overall experience.

### SUMMARY

In some aspects, the techniques described herein relate to a method for operating a network having one or more beverage robots, the method including: receiving an order requesting a beverage from the network, wherein the beverage is associated with a recipe requiring one or more ingredients; assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot; determining, based on the queue at the chosen beverage robot, an estimated completion of the order; and transmitting an update about a status of the order, wherein the status includes data indicating the estimated completion of the order.

In some aspects, the techniques described herein relate to a method, further including: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, adjusting a placement of the order in the queue to synchronize the estimated completion of the order with the estimated time of arrival.

In some aspects, the techniques described herein relate to a method, further including: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, pausing production of the order until a predetermined time before the estimated time of arrival.

In some aspects, the techniques described herein relate to a method, further including: determining a delivery location associated with the order based on information received with the order; determining a reception time associated based on an estimated arrival time of a delivery person and a delivery time associated with traveling from a vending location associated with the network and to the delivery location; and adjusting the recipe based on a difference between the estimated completion of the order and the reception time.

In some aspects, the techniques described herein relate to a method, wherein adjusting the recipe includes: estimating a volume of water from melting ice between the estimated completion of the order and the reception time, wherein the volume from melting ice will dilute the beverage; and adjusting an amount of water in the recipe to account for the volume of water from melting ice.

In some aspects, the techniques described herein relate to a method, further including: receiving, from a client computing device associated with the order, geographic information related to a current location of a customer; determining, based on the geographic information, an estimated time of arrival of the customer at a vending location associated with the network; and adjusting a ratio of the one or more ingredients in the recipe based on a difference between the estimated completion of the order and the estimated time of arrival.

In some aspects, the techniques described herein relate to a method, wherein the update is a first update, and wherein the method further includes: determining an availability of the one or more ingredients at the chosen beverage robot; adjusting a placement of the order in the queue based on the availability of the one or more ingredients; checking an updated status of the order at the chosen beverage robot, wherein checking the updated status includes identifying a remaining queue at the chosen beverage robot ahead of the order and determining an updated estimated completion of the order based on the remaining queue; transmitting a second update about the order, wherein the second update includes information related to the remaining queue and the estimated completion of the order; and receiving a response from a customer, the response indicating an approval to complete the order at the chosen beverage robot.

In some aspects, the techniques described herein relate to a system including: one or more processors; and one or more memories storing instructions that, when executed by the one or more processors, cause the system to perform a process for operating a network having one or more beverage robots, the process including: receiving an order requesting a beverage from the network, wherein the beverage is associated with a recipe requiring one or more ingredients; assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot; determining, based on the queue at the chosen beverage robot, an estimated completion of the order; and transmitting an update about a status of the order, wherein the status includes data indicating the estimated completion of the order.

In some aspects, the techniques described herein relate to a system, wherein the process further includes: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, adjusting a placement of the order in the queue to synchronize the estimated completion of the order with the estimated time of arrival.

In some aspects, the techniques described herein relate to a system, wherein the process further includes: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, pausing production of the order until a predetermined time before the estimated time of arrival.

In some aspects, the techniques described herein relate to a system, wherein the process further includes: determining a delivery location associated with the order based on information received with the order; determining a reception time associated based on an estimated arrival time of a delivery person and a delivery time associated with traveling from a vending location associated with the network and to the delivery location; and adjusting the recipe based on a difference between the estimated completion of the order and the reception time.

In some aspects, the techniques described herein relate to a system, wherein adjusting the recipe includes: estimating a volume of water from melting ice between the estimated completion of the order and the reception time, wherein the volume from melting ice will dilute the beverage; and adjusting an amount of water in the recipe to account for the volume of water from melting ice.

In some aspects, the techniques described herein relate to a system, wherein the process further includes: receiving, from a client computing device associated with the order, geographic information related to a current location of a customer; determining, based on the geographic information, an estimated time of arrival of the customer at a vending location associated with the network; and adjusting a ratio of the one or more ingredients in the recipe based on a difference between the estimated completion of the order and the estimated time of arrival.

In some aspects, the techniques described herein relate to a system, wherein the update is a first update, and wherein the process further includes: determining an availability of the one or more ingredients at the chosen beverage robot; adjusting a placement of the order in the queue based on the availability of the one or more ingredients; checking an updated status of the order at the chosen beverage robot, wherein checking the updated status includes identifying a remaining queue at the chosen beverage robot ahead of the order and determining an updated estimated completion of the order based on the remaining queue; transmitting a second update about the order, wherein the second update includes information related to the remaining queue and the estimated completion of the order; and receiving a response from a customer, the response indicating an approval to complete the order at the chosen beverage robot.

In some aspects, the techniques described herein relate to a non-transitory computer-readable medium storing instructions that, when executed by a computing system, cause the computing system to perform operations for operating a network having one or more beverage robots, the operations including: receiving an order requesting a beverage from the network, wherein the beverage is associated with a recipe requiring one or more ingredients; assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot; determining, based on the queue at the chosen beverage robot, an estimated completion of the order; and transmitting an update about a status of the order, wherein the status includes data indicating the estimated completion of the order.

In some aspects, the techniques described herein relate to a non-transitory computer-readable medium, wherein the operations further include: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, adjusting a placement of the order in the queue to synchronize the estimated completion of the order with the estimated time of arrival.

In some aspects, the techniques described herein relate to a non-transitory computer-readable medium, wherein the operations further include: receiving, from a client computing device associated with the order, geographic information related to a current location of a customer; determining, based on the geographic information, an estimated time of arrival of the customer at a vending location associated with the network; and in response to a determination that the estimated time of arrival is more than a predetermined period after the estimated completion of the order, pausing production of the order until a predetermined time before the estimated time of arrival.

In some aspects, the techniques described herein relate to a non-transitory computer-readable medium, wherein the operations further include: determining a delivery location associated with the order based on information received with the order; determining a reception time associated based on an estimated arrival time of a delivery person and a delivery time associated with traveling from a vending location associated with the network and to the delivery location; and adjusting the recipe based on a difference between the estimated completion of the order and the reception time.

In some aspects, the techniques described herein relate to a non-transitory computer-readable medium, wherein adjusting the recipe includes: estimating a volume of water from melting ice between the estimated completion of the order and the reception time, wherein the volume from melting ice will dilute the beverage; and adjusting an amount of water in the recipe to account for the volume of water from melting ice.

In some aspects, the techniques described herein relate to a non-transitory computer-readable medium, wherein the operations further include: receiving, from a client computing device associated with the order, geographic information related to a current location of a customer; determining, based on the geographic information, an estimated time of arrival of the customer at a vending location associated with the network; and adjusting a ratio of the one or more ingredients in the recipe based on a difference between the estimated completion of the order and the estimated time of arrival.

### BRIEF DESCRIPTION OF THE DRAWINGS

FIG. 1 is a schematic diagram of a system for operating food and/or beverage robots in accordance with some embodiments of the present technology.

FIG. 2 is a schematic network diagram of a system for operating a network of food and/or beverage robots in accordance with some embodiments of the present technology.

FIG. 3 is a block diagram of a platform for operating a network of beverage robots in accordance with some embodiments of the present technology.

FIG. 4 is a block diagram of a subsystem for a beverage robot in accordance with some embodiments of the present technology.

FIG. 5 is a schematic front view of a beverage robot configured in accordance with some embodiments of the present technology.

FIG. 6 is a schematic diagram of a mesh network with a plurality of beverage robots configured in accordance with some embodiments of the present technology.

FIGS. 7A, 7B, and 7C are illustrative examples of a user interface displaying beverage information in accordance with some embodiments of the present technology.

FIG. 8 is a flow diagram of a process for operating a mesh network with a plurality of beverage robots in accordance with some embodiments of the present technology.

FIG. 9 is a flow diagram of a process for a third-party ordering platform to communicate with a mesh network with a plurality of beverage robots in accordance with some embodiments of the present technology.

FIG. 10 is a flow diagram of a process for timing orders in production at a plurality of beverage robots in accordance with some embodiments of the present technology.

FIG. 11 is a flow diagram of a process for adjusting recipe ratios of orders in production at a plurality of beverage robots in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

Disclosed are methods and systems for transmitting instructions between a recipe and robot management system and a distributed network of beverage robots. The management system centrally manages menu and recipe distribution, robot user-interface customization, ingredient information, point-of-sale (POS) integrations, operational and error code communications, and order management for consumable products associated with customers and robots.

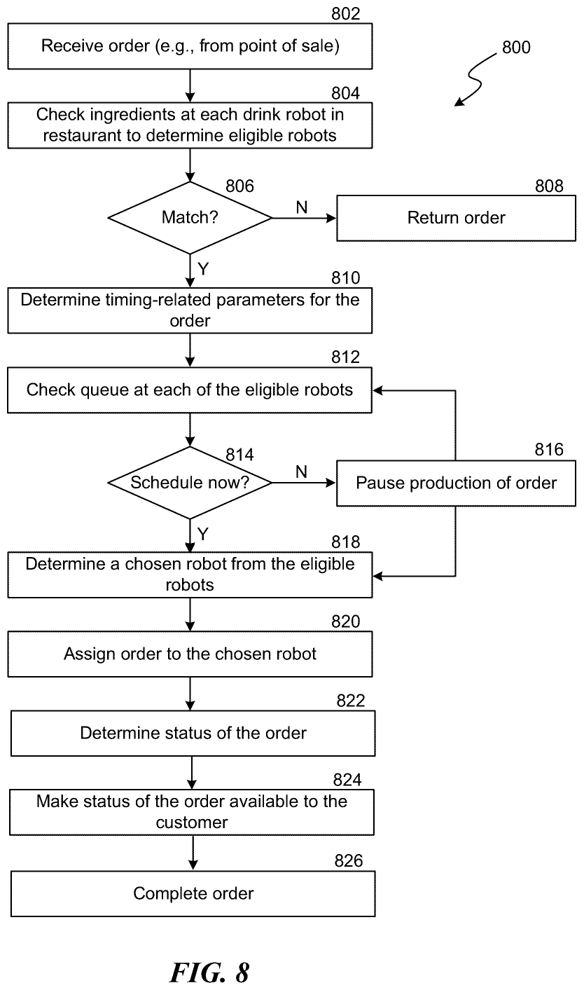

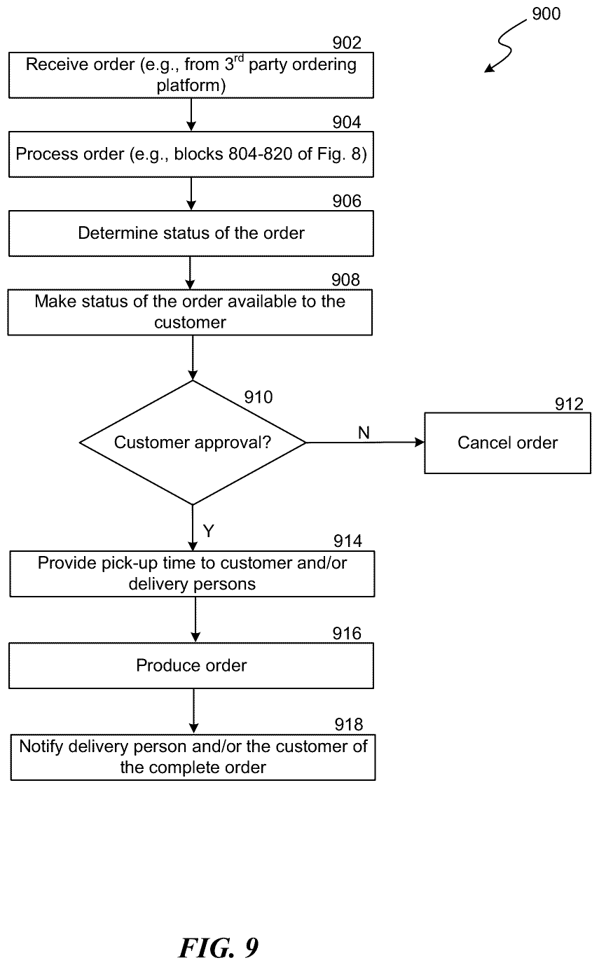

As discussed in more detail below, for example, embodiments of the present technology include processes related to operating a beverage robot at a vending location. The process can include receiving an order requesting a beverage and determining the geographic location information associated with the order. The process can also include determining an estimated time of arrival of the user picking up the order and completing the order within a time threshold of the estimated time of arrival. Additionally, the process can also include determining a delivery time for a delivery person to deliver the beverage from the vending location to a delivery location and adjusting at least one ingredient in the recipe of the beverage based on the delivery time. Although beverage robots are primarily discussed herein, one of skill in the art will understand that the scope of the invention is not so limited. Purely by way of example, the methods disclosed with respect to FIGS. 8-11 can also be used to receive, assign, and manage orders from one or more food robots in addition to (or instead of) one or more beverage robots.

Conventional online ordering systems of restaurants, cafés, coffee shops, tea shops, and/or the like present challenges for consumers and delivery personnel, primarily due to the lack of real-time status updates on beverage preparation. Estimations provided on delivery apps or online platforms are often based on guesses by restaurant employees and may not accurately reflect actual preparation times. This discrepancy becomes particularly noticeable during periods of high order volumes, which leads to wait times significantly longer than estimated. Longer wait times not only inconvenience consumers but also impacts the efficiency of delivery personnel, who waste time waiting for orders. Moreover, longer wait times can affect the quality of beverages. For example, conventional systems often overestimate the time it will take to prepare the beverages (and/or other items) in an order when suggesting a pick-up time to temper expectations and/or reduce the time customers and/or delivery personnel wait at a vending location. The overestimation can cause the beverages (and/or other items) to be completed well ahead of the estimated pick-up time, causing the beverages to sit for long periods of time before they are picked up. As a result, for example, the ingredients in the beverages can be diluted (e.g., by melting ice), ingredients in the beverages can separate, frozen (or partially frozen) beverages (e.g., smoothies) can melt, hot beverages (e.g., coffee, tea, and/or the like) can cool off, and beverage decorations (e.g., beverage toppers) can fade and/or be absorbed into the beverages. In turn, the degradation in quality that is caused by the gap between estimated wait times and actual wait times diminishes overall operational efficiency and customer satisfaction.

To help address these issues, the systems and methods disclosed herein provide one or more beverage robots to the vending locations. Each of the beverage robots can store a variety of ingredients required to prepare a variety of beverages offered at the vending location. As a vending location receives orders, the systems and methods disclosed herein can determine which beverage robots to assign the order to, assign the orders, and/or manage the beverage robots during production of the order. By utilizing beverage robots, the systems disclosed herein can prepare the beverages to produce the order based on recipes for each of the beverages, thereby allowing the systems to prepare each of the beverages in an order in a consistent, predictable amount of time. As a result, the systems can accurately predict when orders will be complete and/or can provide real-time updates on beverage preparation status. Further, the automatic preparation in the beverage robots can help increase throughput at a given vending location, allowing the vending location to reduce a wait time for beverages (and/or other items) during periods of increased demand (e.g., a lunch rush). Still further, the beverage robots can more precisely follow the recipes to improve consistency in the quality of the beverages from the vending location.

Additionally, or alternatively, the systems and methods disclosed herein can dynamically adjust orders in a queue at the beverage robots and/or the recipes that will be used to produce the order. Purely by way of example, the systems and methods disclosed herein can use the location of a customer and/or delivery person to adjust a queue at the beverage robots such that the beverages in their order are completed closer to their arrival at a vending location. As a result, the beverages can be fresher when they are received. In another example, the systems and methods disclosed herein can adjust a recipe based on an estimated pick-up time. In a specific, non-limiting example, the recipe can be adjusted to include additional concentrated ingredients to account for ice melting before the beverage is picked up, which would otherwise dilute the beverage. Additionally, or alternatively, beverage robots can allow the vending locations to offer a wider variety of beverages to their customers, especially when a network of multiple beverage robots with different ingredients is implemented in the vending location.

The implementation of the beverage robots, however, creates numerous technical challenges. For example, while providing differing ingredients in different beverage robots can help expand the range of beverages that can be prepared at the vending location, the differing ingredients can cause one or more of the beverage robots to be unable to prepare one or more of the beverages offered. Further, the network must distribute the orders (or individual beverages in the orders) to help produce the orders efficiently, reduce (or avoid) downtime in a subset of the beverage robots while other robots have a backlog of orders; and/or to account for downtime required to refresh the stock of ingredients, clean the beverage robots, and/or maintain the beverage robots. Still further, it can be desirable to prioritize and/or delay orders based on other time-related parameters associated with an order. Purely by way of example, it can be desirable to delay the production of an order to closer to an estimated pick-up time to improve the freshness of an order (e.g., reduce the amount of melted ice in a cold beverage, reduce the heat lost from a hot beverage before it is served, and/or the like). Additionally, variations in ingredient packages (e.g., beverage-in-boxes) can reduce consistency in the beverages produced by the beverage robots. Purely by way of example, different coffee batches can have varying amounts of acidity (creating varying amounts of bitterness) that produce differences in a beverage prepared according to a recipe.

To overcome these technical deficiencies, the systems and methods disclosed herein include various processes for assigning and managing orders throughout their production. For example, the network of beverage robots can include a primary robot that is in communication with a point-of-sale (POS) system and one or more secondary robots. The primary robot can receive an order from the POS system, retrieve recipes associated with each beverage in the order, and identify the required ingredients for each beverage based on the recipes. The primary robot can then identify, for each beverage in the order, one or more eligible robots that have access to the ingredients required to make the beverage, check the queue at each of the eligible robots, and assign the beverage based on the queue and various time-related parameters. As a result, the primary robot can ensure that beverages are only assigned to beverage robots that have access to the ingredients required to make them. Further, the primary robot can help manage the distribution of beverages among the beverage robots to reduce (or avoid) downtime in the network while one or more beverage robots have a long backlog. Still further, by considering the time-related parameters, the primary robot can help ensure that drinks are prepared as needed (e.g., immediately, closer to a pick-up time, when other items in an order are ready, and/or the like).

Implementing systems that integrate with kitchen operations and provide live updates can improve transparency and accuracy in delivery times. The system can provide food and beverage preparation visibility to the consumer and the delivery partners to help them adjust their behavior, such as delivery routes and expectations. The systems and methods disclosed herein can be utilized beyond beverages and applied to any automation robot. By leveraging technology to share real-time progress updates, businesses can streamline operations, enhance communication with customers and delivery partners, and deliver a seamless and satisfactory experience in the food and beverage delivery industry.

Examples of Suitable Systems for Operating Food and/or Beverage Robots in Accordance with Embodiments of the Present Technology

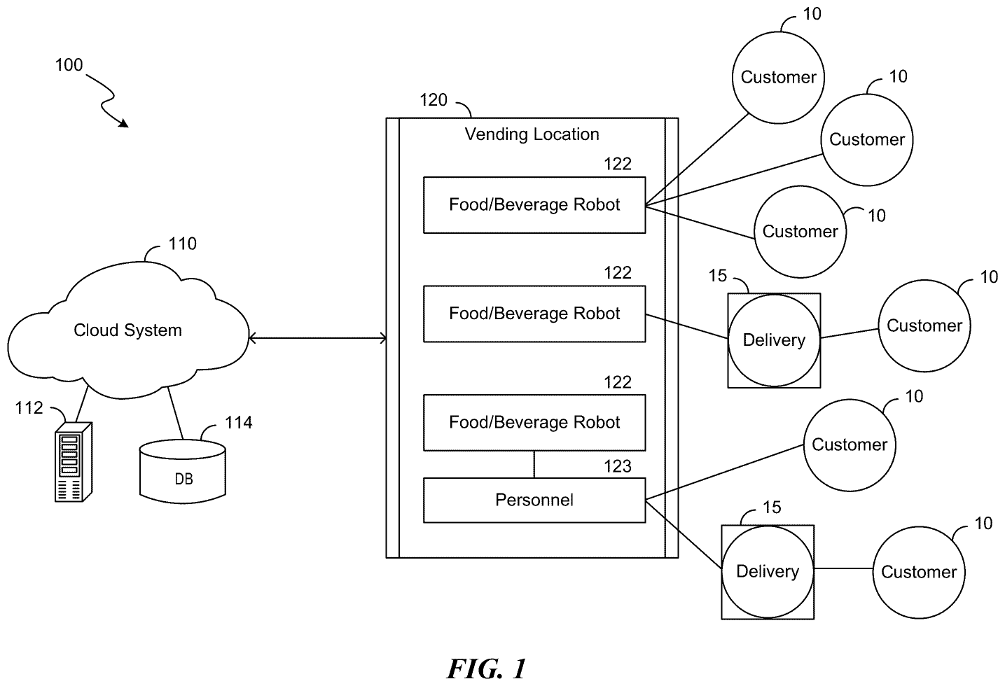

FIG. 1 is a schematic diagram of a system 100 for operating food and/or beverage robots in accordance with some embodiments of the present technology. The system 100 can interconnect a remote system 110 with one or more vending locations 120 (one illustrated in FIG. 1) to operate one or more food/beverage robots 122 (three illustrated in FIG. 1) at each of the vending location(s) 120. As discussed in more detail below, the food/beverage robots 122 can automate the preparation of various food items and/or beverages for customers 10 at the vending location(s) 120. The automation, in turn, can allow the vending location(s) 120 to provide a wider variety of food items and/or beverages, increase the number of the customers 10 the vending location(s) 120 can serve, improve consistency in the taste of the food items and/or beverages, and/or increase transparency into a status of an order and/or an estimated completion time for the order.

As illustrated in FIG. 1, the remote system 110 can include one or more servers 112 (one illustrated in FIG. 1) as well as one or more databases 114 (one illustrated in FIG. 1). The server(s) 112 can be an edge server and/or a cloud-based server with one or more server computing devices configured to perform various operations in support of the food/beverage robots 122. Purely by way of example, as discussed in more detail below, the server(s) 112 can manage orders for food/beverages, queue orders between different sets of the food/beverage robots 122 and/or between different vending location(s) 120, manage and/or monitor food/beverage ingredients, monitor the operation of the food/beverage robots 122 (e.g., check cleaning status, monitor for part malfunctions, predict and/or schedule maintenance, and/or the like), maintain and/or share food/beverage recipes, modify recipes to account for variances in ingredients, and/or the like. The server(s) 112 can include various hardware, such as processing units (e.g., GPUs, CPUs, APUs, and/or the like), working memory, storage memory, input/output devices, displays (e.g., LCD display screens, LED display screens, OLED display screens, and/or the like), a network card, video card, audio card, USB ports, and/or the like. Further, the server(s) 112 are illustrated as a single server, the server(s) 112 can each be a distributed computing environment encompassing multiple computing devices located at the same or at geographically disparate physical locations. Further, the server(s) 112 can correspond to a group of servers supporting the food/beverage robots 122.

The database(s) 114 can warehouse (e.g., store) information, such as drink recipes, lot information or ingredients, stocking keeping units (SKU) information, part information, and/or the like. Though database(s) 114 is illustrated as a single unit, the database(s) 114 can each be a distributed computing environment encompassing multiple computing devices, can be located within one of the server(s) 112 (and/or within a computing device of the server(s) 112), or can be located at the same or at geographically disparate physical locations. The database(s) 114 can include one or more memories, each of which can include various hardware devices for volatile and non-volatile storage. For example, the memory can comprise random access memory (RAM), various caches, CPU registers, read-only memory (ROM), and writable non-volatile memory, such as flash memory, hard drives, CDs, flash drives, magnetic storage devices, and/or the like. The memory is not a propagating signal divorced from underlying hardware; the memory is thus non-transitory. Further, the memory can include sections, such as a program memory section that stores programs and software related to the operation of the food/beverage robots 122 and/or a data memory section that stores data related to the operation of the food/beverage robots 122.

The remote system 110 can be communicatively coupled to various computing devices at the vending location(s) 120 through a network connection (e.g., an internet connection, cellular network, and/or the like). For example, the communication can be implemented through the network using TCP/IP protocols, a Q-LAN protocol, or others. In a specific, non-limiting example, each of the food/beverage robots 122 can include computing components that allow the food/beverage robots 122 to communicate individually (or collectively) with the remote system 110 and/or various other computing devices at the vending location(s) 120 (e.g., point-of-sale systems, on-site servers, and/or the like).

As discussed in more detail below, the communication can allow the remote system 110 to support and/or control (partially or fully) various operations of the food/beverage robots 122 and/or various related operations. For example, the vending location(s) 120 can be any location that serves food items and/or beverages (e.g., a store, café, coffee shop, tea shop, restaurant, food truck, brewery, bar, hotel, resort, conference center, stadium, entertainment center (e.g., a theater, music venue, arcade, bowling center, pool hall, theme park, and/or the like), and/or any other suitable location). The remote system 110 can communicate with the food/beverage robots 122 in the vending location(s) 120 to store and/or communicate recipes for orders; monitor ingredients available at the food/beverage robots 122; assign orders (or portions thereof) to the food/beverage robots 122; monitor personnel 123 at the vending location time the completion of orders based on other aspects of the order, a location of the customers 10, a location of a delivery person 15, and/or the like; monitor a cleaning and/or health status of the food/beverage robots 122; and/or any other suitable operation.

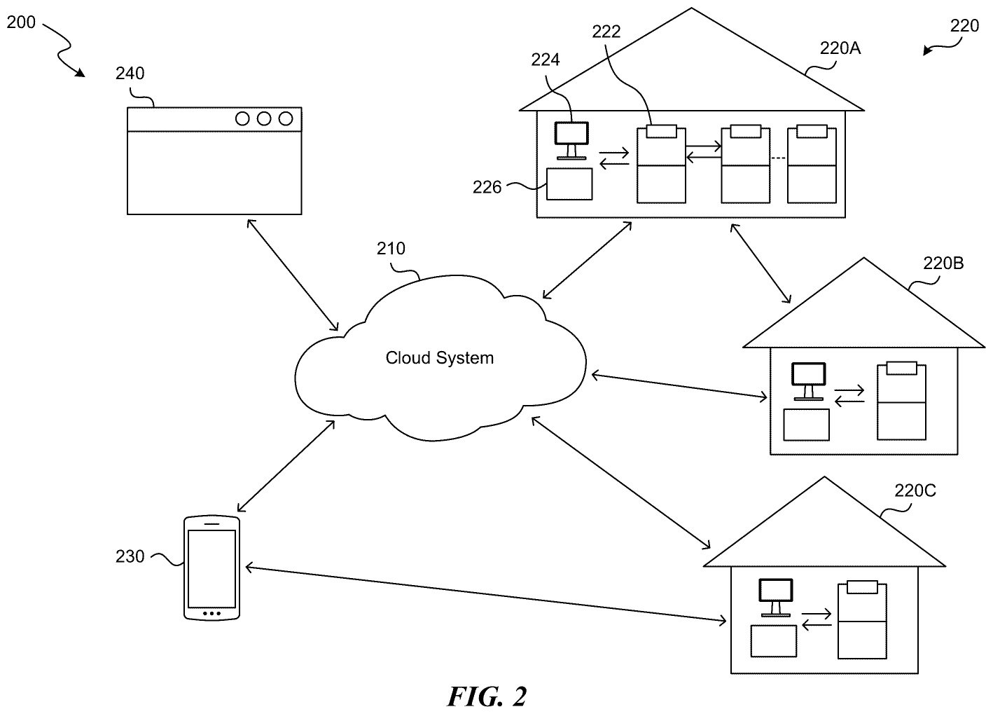

FIG. 2 is a schematic network diagram of an environment in which embodiments of the present technology can operate. The environment can include a remote system 210 (e.g., a cloud computing system) generally similar (or identical) to the remote system 110 discussed above with respect to FIG. 1. For example, the remote system 210 can include one or more servers (e.g., the servers of FIG. 1) as well as one or more databases (e.g., the databases 114 of FIG. 1) that allow the remote system 210 to support and/or facilitate various operations in the environment 200. As further illustrated in FIG. 2, the environment 200 can also include one or more vending locations 220 (three illustrated in FIG. 2, referred to individually as first-third vending locations 220A-220C), one or more client computing devices 230 (one illustrated in FIG. 2), and one or more third-party platforms 240 (one illustrated in FIG. 2). As further illustrated in FIG. 2, the vending locations 220, client computing devices 230, and third-party platforms 240 are each communicatively coupled to the remote system 210 (e.g., via a network connection). As a result, as discussed in more detail below, the remote system 210 can help support, facilitate, and/or control operations at each of the vending locations 220, the client computing devices 230, and/or the third-party platforms 240. Additionally, or alternatively, the remote system 210 can provide a connection and/or facilitate communications between the vending locations 220, the client computing devices 230, and/or the third-party platforms 240.

Similar to the discussion above, the vending locations 220 can include any location providing food and/or beverage sales to customers. In a non-limiting example, the first vending location 220A can be a restaurant, the second vending location 220B can be a food truck, and the third vending location 220C can be a coffee shop. Further, each of the vending locations 220 can include one or more food/beverage robots 222, a point-of-sale (POS) system 224, and/or an onsite computing system 226. The food/beverage robots 222, the POS system 224, and the onsite computing system 226 can be communicably coupled by a network (e.g., the internet, a local area network (LAN), a wide area network (WAN), and/or the like), one or more wired connections, and/or various shortrange wireless communication components (e.g., Bluetooth®, Zigbee®, Z-Wave®, HaLow®, Wi-Fi, NearLink, near-field communication (NFC), low-power WAN, ultra-wideband (UWB), and/or the like). As a result, the food/beverage robots 222, the POS system 224, and the onsite computing system 226 can help partially (or fully) automate transactions and the production of orders received at each of the vending locations 220.

For example, as discussed in more detail below, the food/beverage robots 222 can store and/or have access to any suitable number of ingredients and automate the preparation of various food items and/or beverages. Purely by way of example, the food/beverage robots 222 can store a plurality of bag-in-boxes (BIBs) that each has concentrated ingredients for various different beverages (e.g., juice blends, sodas, teas, boba drinks, coffee drinks, energy drinks, matés, milk drinks, milkshakes, lemonades, flavored water, flavored sparkling water, mocktails, probiotic drinks, and/or the like). The food/beverage robots 222 can access one or more of the BIBs in response to an order and automatically mix the ingredients to prepare one or more beverages in the order. The POS system 224 can include various devices to receive and process transactions and generate orders for the food/beverage robots 222. For example, the POS system 224 can include cash registers, electronic terminals (e.g., touchscreen terminals), virtual terminals (e.g., accessible through an app on a customer's phone, a web browser, and/or the like), credit card readers, chip readers, and/or the like. Once a transaction is processed, for example, the POS system 224 can send the order(s) associated with the transaction to the food/beverage robots 222 to be prepared. The onsite computing system 226 can include desktop computers, laptops, server computing devices, databases and other storage devices, and/or the like to provide computational services (e.g., order processing, order distribution, order management, order change requests, recipe management, ingredient management, maintenance scheduling, cleaning scheduling, quality control, and/or the like) for the POS system 224 and/or the food/beverage robots 222. Said another way, the onsite computing system 226 can provide local services that support the operations discussed herein as additional, or peripheral, computing devices to the remote system 210.

The client computing devices 230 can include wireless smartphones, wireless tablets, desktop computers and other computer systems (e.g., server computers), wireless laptops, digital assistants, virtual assistants, other smart devices (e.g., smart watches, smart glasses, and/or the like), internet-of-things (IoT) devices, and/or the like. The client computing devices 230 allow users (e.g., customers, vending location staff and/or personnel, maintenance personnel, brand personnel, and/or the like) to access different components of the environment 200. For example, a customer can access the remote system 210 and/or the POS system 224 in any of the vending locations 220 through their smartphone to place an order. In another example, a manager at one of the vending locations 220 can access the remote system 210 and/or the food/beverage robots 222, the POS system 224, and/or the onsite computing system 226 through a laptop computer to monitor information on the vending locations 220 (e.g., stock levels for the ingredients, maintenance warnings/schedules, cleaning schedules, order history, order trends, and/or the like).

The third-party platforms 240 can be implemented on various suitable computing devices and/or systems (e.g., server computing systems, laptop computers, desktop computers, smart devices, and/or the like). The third-party platforms 240 can provide peripheral services to the remote system 210 and/or any of the other components in the environment 200. Purely by way of example, the third-party systems can include a sales, marketing, and deployment tracking platform (e.g., ClickUp and/or the like) that helps the remote system 210 monitor the deployment of the food/beverage robots 222, sales across the environment 200, and/or the like. Additionally, or alternatively, the sales, marketing, and deployment tracking platform can help any of the vending locations 220 monitor the deployment of the food/beverage robots 222, track their sales, market their food/beverage options, and/or the like.

In another example, the third-party platforms 240 can include a data visualization and analytics platform (e.g., Tableau, Looker, and/or the like). The data visualization and analytics platform can work with raw data from the remote system 210 and/or any of the vending locations 220 (or any specific components therein) to summarize and/or analyze the data. In a specific, non-limiting example, the data visualization and analytics platform can identify sales trends in the data for the remote system 210, allowing the remote system 210 to make recommendations to the vending locations 220 on what ingredients to stock, popular recipe trends, recipes trends specific to the vending location area and/or type, and/or the like. Additionally, or alternatively, the data visualization and analytics platform can record data on needed maintenance, maintenance schedules, cleaning schedules, and/or the like to help the remote system 210 and/or the vending locations 220 track the status of the food/beverage robots 222.

In yet another example, the third-party platforms 240 can include a customer support platform (e.g., Freshdesk and/or the like). The customer support platform can supplement (or provide) a service dashboard in the remote system 210 to help the remote system 210 provide services to the vending locations 220. In a specific, non-limiting example, the customer support platform can use the raw data (and/or analyses from the data visualization and analytics platform) to respond to calls from the vending locations 220 regarding the status of the food/beverage robots 222. Further, the customer support platform can help proactively monitor and manage the health of the food/beverage robots 222 (e.g., using data from the data visualization and analytics platform to schedule maintenance ahead of a breakdown). Additionally, or alternatively, the vending locations 220 can be connected to the customer support platform through the remote system 210 to provide customer support at the vending locations (e.g., answer questions about transactions, complaints about orders, suggestions for the vending locations 220, issue refunds, and/or the like).

In yet another example, the third-party platforms 240 can include an enterprise resource planning (ERP) platform. The ERP platform can help the remote system 210 and/or the vending locations 220 manage invoices, orders, inventory, and/or the like. In a specific, non-limiting example, the remote system 210 can be integrated with the ERP platform to track SKU information on the ingredients used in each of the food/beverage robots 222 to alert the vending locations 220 and/or automatically order additional inventory when the ingredients are low. Additionally, or alternatively, the vending locations 220 can access the ERP platform to help track the invoices associated with ingredients they order, and/or the like.

In yet another example, the third-party platforms 240 can include a third-party logistics (3PL) platform (e.g., Logiwa). The 3PL platform can help the remote system 210 manage warehouse and shipping logistics to provide and/or install the food/beverage robots 222 in the vending locations 220, provide and/or install parts for the food/beverage robots 222, provide ingredients for the vending locations 220, and/or the like. Additionally, or alternatively, the 3PL platform can help the remote system 210 manage various special orders (e.g., modifications to customize the food/beverage robots 222 to any of the vending locations 220, customized ingredient orders, and/or the like) from the vending locations 220.

Although discussed above as being connected through the remote system 210, the vending locations 220, the client computing devices 230, and/or the third-party platforms 240 can communicate directly. For example, as illustrated in FIG. 2, the first vending location 220A can directly communicate with the second vending location 220B. The direct communication can allow, for example, the first and second vending locations 220A, 220B to share orders (or portions thereof) independent from control and/or supervision from the remote system 210. The direct communication and independent control, in turn, can reduce the resources required in the remote system 210 to support the operation of the first and second vending locations 220A, 220B. In another example, the client computing device 230 can communicate directly with the third vending location 220C. The direct communication can allow, for example, the third vending location 220C to receive order(s) directly from the client computing device 230, without any delays relaying the order through the remote system 210.

Further, although the vending locations 220 are illustrated in FIG. 2 as each having at least one of the food/beverage robots 222, the POS system 224, and the onsite computing system 226, it will be understood that the systems and methods disclosed herein are not so limited. For example, any of the vending locations 220 can omit the food/beverage robots 222 and instead communicate with another of the vending locations 220 (directly or through the remote server) to produce orders. In another example, any of the vending locations 220 can omit the POS system 224 and/or the onsite computing system 226. Instead, the remote system 210 can receive, distribute, manage, and/or track orders on behalf of the vending locations 220 and/or provide any necessary computational services.

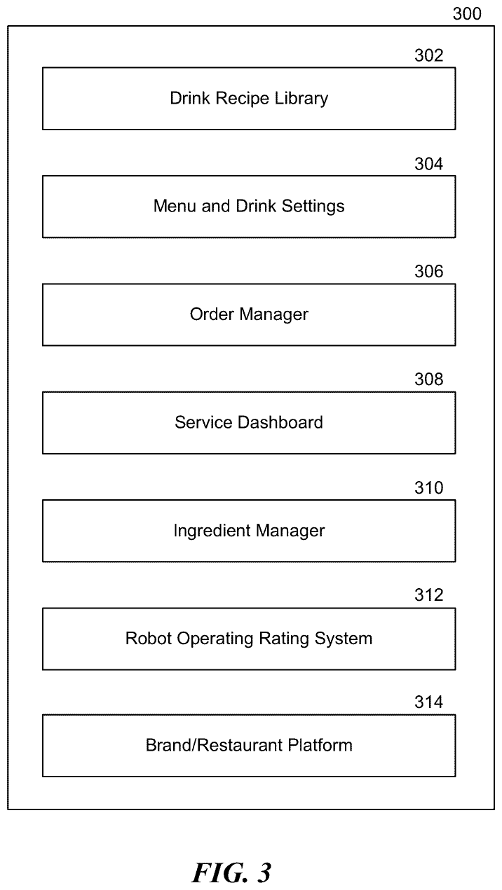

FIG. 3 is a block diagram of a platform 300 for operating a network of beverage robots in accordance with some embodiments of the present technology. The platform 300 can be implemented in one or more computing devices, such as the remote system 210 discussed above with reference to FIG. 2, to help support, manage, and/or control operations in a variety of vending locations. For example, the platform 300 can be implemented on one or more processors of a computing system with access to any suitable number of storage components to facilitate the operations of the platform 300 as described herein. Further, as illustrated in FIG. 3, the platform 300 can include one or more modules (seven illustrated in FIG. 3, referred to individually as first-seventh modules 302-314), various examples of which are discussed in more detail below.

The first module 302 can include a drink recipe library. The drink recipe library can include information on the proportions of ingredients for a variety of beverages, such as juice blends, sodas, teas, boba drinks, coffee drinks, energy drinks, matés, milk drinks, milkshakes, lemonades, flavored water, flavored sparkling water, mocktails, probiotic drinks, and/or the like. In some embodiments, the recipes include specific ratios (e.g., percentages of different ingredients such as 5% a first juice, 5% a second juice, 1% simple syrup, 40% ice, and 39% water; ratios of ingredients such as 1 part tea concentrate, 0.5 parts ice, 1 part water; and/or the like). Additionally, or alternatively, the recipes can include various nutrient tables, acidity information, sweetness information, concentration information, and/or the like related to how a beverage should taste. In such embodiments, the drink recipe library can allow beverage robots to vary the exact ratios of ingredients to account for variations in the ingredients (e.g., using more or less of a juice concentrate based on variations in different batches, using more or less simple syrup to compensate for variations in the acidity of batches of coffee concentrate, and/or the like). Further, the drink recipe library can have recipes that allow beverage robots to produce beverages of any size, beverages in a range of sizes (e.g., common sizes such as 16 ounces (oz), 20 oz, 24 oz, and/or the like), and/or only beverages of a specified size (e.g., 16 oz of an energy drink to limit the caffeine provided in a single beverage).

Still further, the drink recipe library in the first module 302 can include a variety of generic recipes, a list of previously customized recipes, branded recipes, and/or the like. The generic recipes can be baseline recipe suggestions for a variety of drinks that a vending location can customize based on taste preferences and/or customer feedback. Any customized recipe can then be stored to be accessed, used, and/or customized by other vending locations. The branded recipes can be specific to drink and/or beverage brands (e.g., juice brands, sports drink brands, coffee brands, tea brands, soda brands, energy drink brands, health drink brands, smoothie brands, milkshake brands, and/or the like) and/or specific to vending locations (e.g., specific to stores of a specific a franchise name). The first module 302 (and/or a related module) can advertise the availability of the branded drinks but restrict access to the recipes until approved by the brand. For example, the first module 302 can require a vending location to pay an upfront fee and/or royalties to access a branded recipe. In another example, the first module 302 can allow a brand to review an access request to control where their branded drinks are available and/or check for quality control at the vending locations requesting access. Additionally, or alternatively, the first module 302 can monitor customized recipes for imitations of branded recipes to help prevent vending locations from copying branded drinks after accessing them once.

The second module 304 can help generate menu and drink settings for a vending location. For example, the second module 304 can keep track of the required ingredients for recipes as a vending location builds a menu, prevent the vending location from selecting recipes requiring additional ingredients once they reach a limit on the ingredients the beverage robots can store, and/or suggest additional beverages based on the ingredients at the vending location (e.g., other beverages that can be created without additional ingredients). Additionally, or alternatively, the second module 304 can use information about the vending location (e.g., restaurant type, sales in a surrounding area, demographic information around the vending location, seasonal information, and/or the like) to suggest recipes for the menu. Purely by way of example, the second module 304 can recommend that a pizza restaurant stock ingredients for lemonade, sodas, sports drinks, and/or the like based on those beverages typically selling well with pizza. In another example, the second module 304 can recommend a vending location near a university to stock ingredients for coffee, energy drinks, and/or the like based on demographic information for the vending location. Still further, once a vending location has selected recipes for their beverage robot(s), the second module 304 can generate a menu (e.g., a user interface for a virtual menu) with the recipes and provide the menu to the vending location POS and/or the beverage robot.

The third module 306 can provide an order manager to one or more vending locations. The order manager can queue orders (or individual beverages from orders) to be produced by the beverage robot(s). For example, the order manager can determine which beverage robot in a café will be able to produce an order fastest based on existing queues at each beverage robot in the café, then add the order to the queue at the chosen beverage robot. In some embodiments, orders are scheduled based on estimated completion times and estimated pick-up times. For example, when a customer orders through an app on their phone, the order manager can estimate when they will arrive at the café and delay the production of their order until closer to the arrival time. As a result, the order will be fresher when picked up than if the order had been queued and produced when received. In another example, the order manager can receive a take-out/delivery order for a beverage from a first restaurant, determine that a second restaurant can provide the beverage to the customer sooner, and present the customer with the option to receive the beverage from the second restaurant. By producing the order from a recipe with a beverage robot, the customer can then receive the same drink (as customized to the first restaurant) from the second restaurant. Further, the first and second restaurants can expand their sales by making the beverages more convenient/quicker to receive. In yet another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive customizations and/or order changes. Further, because the order manager can track the status of an order through production, the order manager can allow a customer to seamlessly make changes to their order until the order is prepared by the beverage robot(s).

The fourth module 308 can provide a service dashboard for vending location personnel and/or personnel associated with the beverage robots. The service dashboard can provide a record of statistics and data from the beverage robots (e.g., past and scheduled maintenance, health status of beverage robots, cleaning status of beverage robots, usage of beverage robots, and/or the like). In a specific, non-limiting example, the service dashboard can show that one or more tubes in a beverage robot are locked, along with an error code explaining why they are locked (e.g., spoiled ingredients, required cleaning, connection malfunction, and/or the like). As a result, the service dashboard can allow personnel associated with the beverage robots to respond to inquiries from vending locations and/or guide them through correcting the error. Additionally, or alternatively, the service dashboard can allow vending location personnel to address issues without contact with other maintenance personnel. In some embodiments, the service dashboard in the fourth module 308 can communicate with one or more additional modules (e.g., the sixth module 312 discussed in more detail below) to provide information related to the health status of beverage robots, cleaning data related to the beverage robots, usage of the beverage robots, and/or the like.

The fifth module 310 can include an ingredient manager. The ingredient manager can receive SKU information for shipments to vending locations and ingredient packages (e.g., BIBs) as they are used by the beverage robots. The ingredient manager can use the SKU information to track ingredient consumption in vending locations. Additionally, or alternatively, the ingredient manager can track and/or identify ingredients from specific batches (e.g., to prompt the first module 302 to adjust a recipe for variations between batches, identify recalled batches, and/or the like). Further, the ingredient manager can track ingredient expiration dates (e.g., milk and other spoilable ingredients) and prompt vending locations to replace ingredients close to their expiration. Still further, the ingredient manager can receive information from one or more sensors in the beverage robots related to ingredients remaining in a package (e.g., dispensing information, weight measurements, volume measurements, and/or the like) to help track and manage inventory for a vending location. The ingredient manager can then prompt a vending location to replace (or plan to replace) empty packages in the beverage robots, order more packages as their inventory goes down, and/or the like. In some embodiments, the ingredient manager automatically manages inventory (e.g., tracks and orders inventory) for a vending location to make sure they are stocked on ingredients. In some such embodiments, the ingredient manager accounts for sales trends, sales forecasts, and/or the like while managing inventory. Purely by way of example, the ingredient manager can stock additional ingredients for cold beverages ahead of a heat wave in anticipation of increased sales to make sure the vending location has adequate inventory.

The sixth module 312 includes a robot operating rating system. The robot operating rating system can use data from beverage robots at a vending location to evaluate and/or grade the vending location. For example, the robot operating rating system can consider data related to cleaning cycles and cleaning times of the beverage robots, error codes and responses to error codes, employee certification and training, inventory management from vending locations, shelf-life management from vending locations, and/or the like. The data can then be used to generate food safety ratings, grade the operation of the beverage robots, improve quality control for the operation of the beverage robots, and/or the like. The sixth module 312 can then use the ratings to adjust maintenance schedules for the beverage robots (e.g., increase maintenance when vending locations do not respond well to error codes), adjust the operation of the beverage robots (e.g., prevent robots from dispensing spoiled ingredients), and/or provide the ratings to franchise owners and/or brands to help monitor the vending locations for quality control.

The seventh module 314 can provide a platform for brands/vending locations to market themselves and/or interact. For example, brands can create beverage recipes that they market through the seventh module. Vending locations can review available brands as they generate (or refresh) their menu offerings, then contract with the brands through the seventh module 314. Additionally, or alternatively, brands can contact vending locations through the seventh module to place their beverages in a variety of locations. Further, the seventh module 314 can communicate with various other modules on the platform 300. Purely by way of example, the seventh module 314 can communicate with the sixth module 312 to make ratings of vending locations available to brands as they decide whether to contract with a vending location. Similarly, the seventh module 314 can obtain sales data associated with branded drinks to provide the sales data to vending locations as they decide whether to work with a brand. As a result, the seventh module 314 can help increase transparency between brands and vending locations, increase quality control for branded beverages, and/or the like.

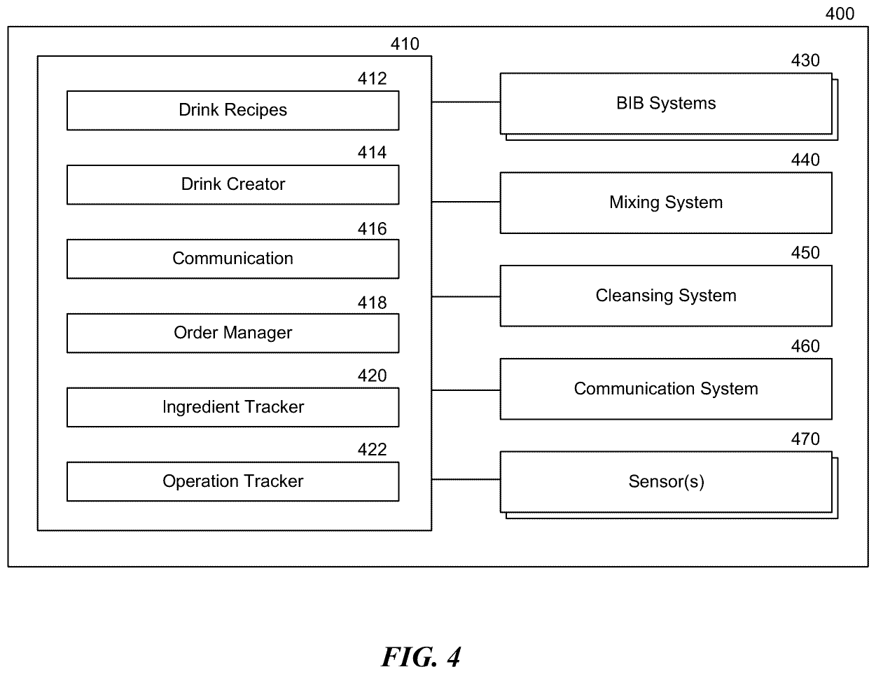

FIG. 4 is a block diagram of a subsystem 400 for a beverage robot in accordance with some embodiments of the present technology. The subsystem 400 can be deployed, for example, in the food/beverage robots 222 discussed above with respect to the environment 200 of FIG. 2. A processor and/or a storage component are not illustrated in FIG. 4 to avoid obscuring the illustrated components of the subsystem 400. However, one of skill in the art will understand that the subsystem 400 can include one or more processors and any suitable number of storage components to facilitate various operations of the subsystem 400 described herein.

As illustrated in FIG. 4, the subsystem 400 includes an operating platform 410 (“platform 410”) with one or more modules (six shown, referred to individually as first-sixth modules 412-422), as well as one or more BIB systems 430 (and/or other suitable ingredient containers), a mixing system 440, a cleansing system 450, a communication system 460, and one or more sensors 470.

The BIB systems 430 can store various concentrated ingredients related to beverage offerings from the subsystem 400. The mixing system 440 can receive and mix ingredients from the BIB systems 430 according to a recipe in a relatively short time (e.g., in less than a minute per beverage, less than 40 seconds per beverage, less than 30 seconds per beverage, and/or the like). In various embodiments, the mixing system 440 can include a blending component, shaking component, stirring component, emulsifying component, and/or any other suitable system to mix the ingredients according to the recipe. The cleansing system 450 can clean the mixing system 440, and/or any tubing and/or valves between the BIB systems 430 and the mixing system 440. The cleansing system 450 can be configured to operate between each beverage to avoid flavor contamination between beverages. Additionally, or alternatively, the cleansing system 450 can operate periodically to kill bacteria and/or build up in the tubing and/or valves.

The communication system 460 can operably couple the subsystem 400 to various other subsystems and/or platforms, such as other beverage robots, the POS system 224 of FIG. 2, and/or the platform 300 of FIG. 3. In various embodiments, the communication system 460 can include components configured to communicate over a shortrange wireless standard (e.g., a Bluetooth®, Zigbee®, Z-Wave®, Wi-Fi HaLow®, or any other suitable shortrange standard), communicate with a network over a wireless (or wired) internet connection (e.g., a WiFi connection or ethernet connection), and/or communicate with the network through a cellular internet connection (e.g., based on a 3G, 4G, LTE, 5G, 6G, or other standard).

The sensors 470 can be coupled to various components of the subsystem 400 to help monitor the operation of the beverage robot. For example, the sensors can include weight and/or volume sensors coupled to the BIB systems 430 to measure remaining ingredients in each BIB; temperature sensors in the BIB systems 430 to help monitor a freshness and/or status of ingredients; volumetric dispensing sensors to monitor the volume of ingredients provided to the mixing system 440; operating sensors coupled to the cleansing system 450 to monitor a frequency of cleansing; and/or the like. Additionally, or alternatively, the sensors 470 can include sensors that monitor connections between the BIB systems 430 and the mixing system 440 to make sure tubes, valves, and/or nozzles are properly connected and in good health; and/or other sensors to monitor a health condition of the beverage robot.

The platform 410 can be operably coupled to each of the BIB systems 430, the mixing system 440, the cleansing system 450, the communication system 460, and/or the sensors 470 to facilitate various operations of the beverage robot via the first-sixth modules 412-422 (and/or any other suitable modules). For example, the first module 412 can store drink recipes specific to the beverage robot, access the drink recipe library in the first module 302 of FIG. 3, and share drink recipes with other beverage robots (e.g., to allow the other beverage robots to prepare the recipe) and/or receive recipes from other beverage robots. Further, the first module 412 can communicate with a POS system and/or other user interface to share information on the beverages available in the subsystem 400.

The second module 414 includes a drink creator. The drink creator can allow a vending location to customize a drink recipe from the first module 412 (e.g., adjusting the portions of ingredients, adding or removing ingredients, changing an order the ingredients are added/mixed, and/or the like). Accordingly, the drink creator can allow the vending location to customize generic recipes to preferences of the vending location. Additionally, or alternatively, the drink creator in the second module 44 can communicate with a POS system and/or other user interface to allow a user (e.g., a customer) to customize a beverage to their preferences (e.g., to change milk types, remove an ingredient, add an ingredient, and/or the like).

The third module 416 can include a communication manager. The communication manager can work with any of the modules in the platform 410 and/or any of the other components of the subsystem 400 to communicate outside of the subsystem 400. In a specific, non-limiting example, the communication manager can help direct communications between the first module 412 and a drink library in the remote system 210 of FIG. 2 to move drink recipes therebetween. In another specific, non-limiting example, the communication manager can send data from the sensors 470 to the robot operating rating system in the sixth module 312 discussed above with reference to FIG. 3.

The fourth module 418 can include an order manager. Similar to the order manager discussed above with reference to FIG. 3, the order manager can queue orders (or individual beverages from orders) to be produced by the beverage robot associated with the subsystem 400 and/or various other beverage robots in communication with the subsystem 400. For example, the order manager can queue orders at beverage robots with shorter wait times and the necessary ingredients. Additionally, or alternatively, the order manager can queue orders to sync estimated completion times with estimated pick-up times. In another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive order changes after an order is queued, modify the order in the queue, then produce the order. The on-site accessibility of the order manager can increase a speed of the order management and/or allow a vending location to override order queuing directly from the subsystem 400.

The fifth module 420 can include an ingredient tracker. Similar to the ingredient manager discussed above with reference to FIG. 3, the ingredient tracker can help monitor a volume of ingredients remaining in each of the BIB systems 430, track an age of the ingredients in the BIB systems 430, and/or the like. As a result, the ingredient tracker can notify a vending location when one of the BIB systems 430 needs to be replaced or will need to be replaced soon. Additionally, or alternatively, the ingredient tracker can help monitor overall volumes of ingredients used during a relevant time period to identify popular (or unpopular ingredients). The information can be useful, for example, in managing the vending location's inventory and orders related to various ingredients. Still further, the ingredient tracker can help identify ingredients approaching their expiration date, prompt the vending location to change the ingredients, and/or prevent the subsystem 400 from vending expired ingredients.

The sixth module 422 can include an operation tracker. The operation tracker can be communicably coupled to the order manager in the fourth module 418, the BIB systems 430, the mixing system 440, the sensors 470, and/or any other suitable components of the subsystem 400 to record operations thereof. As a result, the operation tracker can help track drink sales, identify cleaning and/or maintenance patterns, ensure the BIB systems 430 are properly installed, track how often the BIB systems 430 are swapped, whether the correct BIB systems 430 are swapped, whether the mixing system 440 is properly cleaned between orders, and/or the like. The information can be used by the vending location to help improve sales, identify popular (or unpopular) beverages, improve quality control, monitor staff operations, and/or the like. Additionally, or alternatively, the information can be used to schedule (or predict) maintenance for the beverage robot. Additionally, or alternatively, the information can be shared with an external system, such as the service dashboard and/or robot operating rating systems discussed above with reference to FIG. 3.

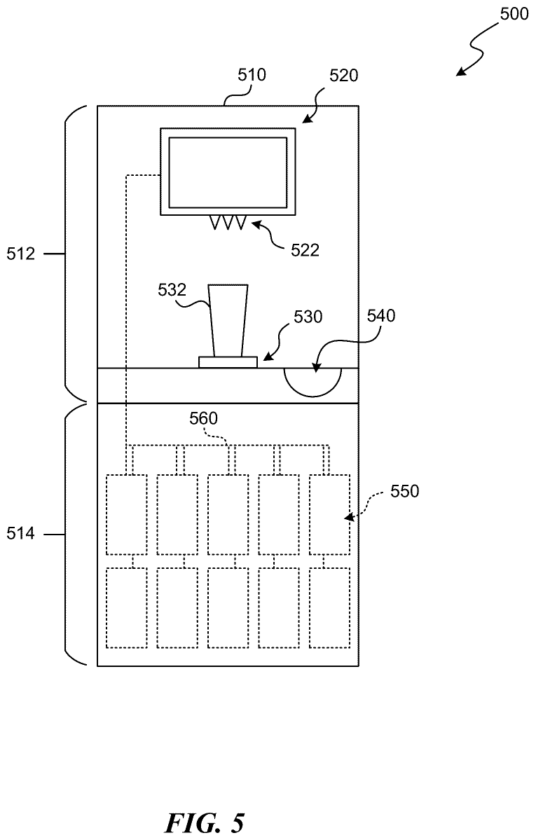

FIG. 5 is a schematic front view of a beverage robot 500 configured in accordance with some embodiments of the present technology. In the illustrated embodiment, the beverage robot 500 includes a housing 510 having an upper portion 512 and a lower portion 514 fluidly coupled to the upper portion 512. The upper portion 512 (sometimes also referred to as a “mixing portion,” an “active blending portion,” and/or the like) can include a dispensing head 520 positioned above a mixing driver 530 and a mixing container 532. The dispensing head 520 can include one or more nozzles 522 (three shown in the illustrated embodiment) that are positioned to dispense ingredients (e.g., concentrated juices, coffee, tea, syrups, water, sparkling water, and/or the like) into the mixing container 532. The mixing driver 530 can include a blender, shaker, emulsifier, and/or any other suitable component. The mixing container 532 can include a detachable container, an open container (e.g., an open cup), a closable container, and/or any other suitable component. As further illustrated in FIG. 5, the upper portion 512 can also include a cleansing system 540 adjacent to the mixing driver 530. The cleansing system 540 can include a glass rinser/washer that is configured to dispense water and/or a cleaning solution into the mixing container 532 and a draining component (e.g., a sink) to receive and carry used water and/or cleaning solution away from the mixing container 532. In some embodiments, the cleansing system 540 includes an automatic scrubber positioned to scrub the mixing container over the draining component.

During operation, the beverage robot 500 can dispense one or more ingredients through the dispensing head 520 and into the mixing container 532. The beverage robot 500 can then operate the mixing driver 530 to mix, blend, emulsify, and/or otherwise combine the ingredients in the mixing container 532. The beverage robot 500 can then repeat the process to dispense one or more additional ingredients and combine ingredients in the mixing container 532 according to a recipe for a current beverage. Additionally, or alternatively, the beverage robot 500 can dispense one or more ingredients to top the current beverage. A user of the beverage robot 500 (e.g., staff at a restaurant) can then pour the beverage out of the mixing container 532 into a container for the customer (e.g., a cup, disposable cup, bottle, carafe, bowl, and/or any other suitable container). Once empty, the user can position the mixing container 532 over the cleansing system 540 and operate the cleansing system 540 to clean and/or sanitize the mixing container 532. The user can then reset the mixing container 532 on the mixing driver 530 to prepare the beverage robot 500 for the next beverage.

As illustrated in FIG. 5, the lower portion (sometimes referred to as a “storage portion,” a “refrigeration portion,” and/or the like) can store one or more ingredient packages 550 (e.g., the BIB systems 430 discussed above with reference to FIG. 4). Each of the ingredient packages 550 can contain a concentrated ingredient that is used in one or more recipes that the beverage robot 500 can prepare. The ingredient packages 550 can be independently accessible and/or replaceable, allowing the user to swap packages as supply in any of the ingredient packages 550 runs low. In some embodiments, the lower portion 514 is refrigerated to keep the ingredient packages 550 at or below a predetermined temperature. In some embodiments, the lower portion 514 includes one or more sub-portions. A first sub-portion can be refrigerated to preserve perishable ingredients while a second sub-portion is not refrigerated (or heated) and stores non-perishable ingredients. The second sub-portion can be useful, for example, to store ingredients that become too viscous to adequately dispense when cooled.

As further illustrated in FIG. 5, each of the ingredient packages 550 can be fluidly coupled to the dispensing head 520 through vending lines 560. The vending lines 560 can include various components (e.g., valves, tubing connections, pumps, volumetric meters, pre-mixing components, and/or the like) to quickly provide ingredients to the dispensing head 520 with accurate volumetric amounts. In some embodiments, the vending lines 560 include a cleansing system configured to clean one or more of the tubing connections between beverages to reduce (or eliminate) cross-contamination. Further, in various embodiments, the lower portion 514 can be positioned directly beneath the upper portion 512 and/or can be separated from and fluidly coupled to the upper portion 512. In embodiments where the lower portion 514 is separated from the upper portion 512, the beverage robot 500 can include longer vending lines 560 and/or additional compression components to move ingredients between the lower portion 514 and the dispensing head 520.

Specific Examples of Mesh Networks of Beverage Robots and Methods for Operating the Mesh Networks in Accordance with Embodiments of the Present Technology

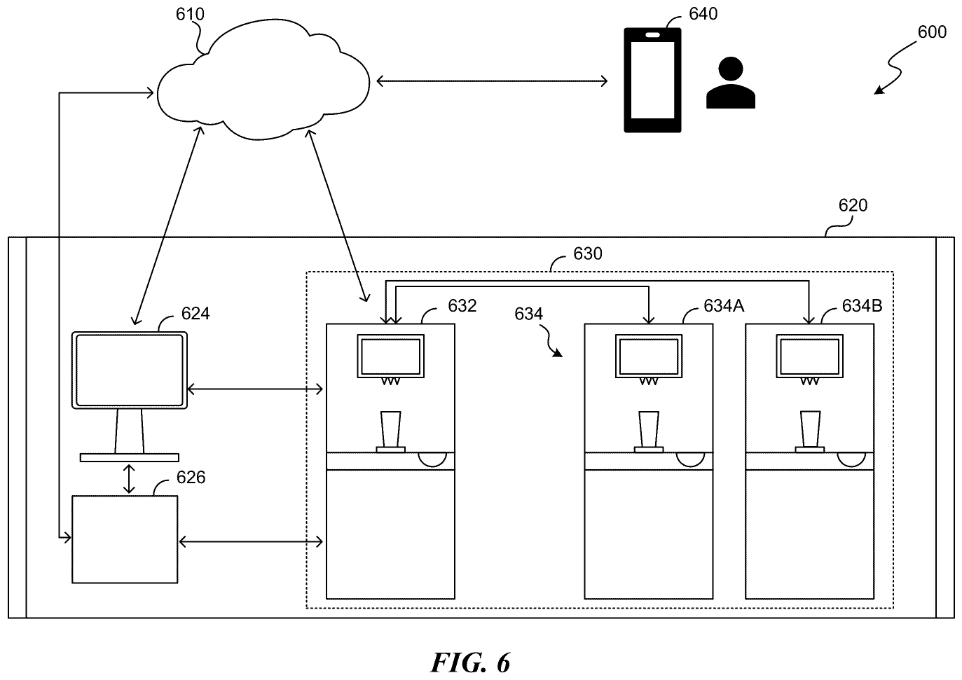

FIG. 6 is a schematic diagram of a mesh network 600 configured in accordance with some embodiments of the present technology. The mesh network 600 can allow a remote system 610 and/or a vending location 620 (e.g., any location that serves beverages) to receive orders, automatically prepare the beverages in the orders, track the orders during production, and/or execute various related tasks. Further, while the mesh network 600 can communicate with the remote system 610 to produce and/or manage orders, the components of the vending location 620 discussed in more detail below can allow the vending location to execute most (or all) of the processes related to producing and/or managing orders independent from the remote system 610. For example, the components of the mesh network 600 at the vending location 620 can receive an order requesting one or more beverages, accurately estimate a time of completion for the order, and track the order throughout production to provide increased transparency on the order and/or dynamically update the estimated completion time. In another example, the components of the mesh network 600 at the vending location 620 can estimate a reception time for the order (e.g., an in-store pick-up time and/or a delivery time), predict changes in the beverage quality in any gap between the completion time and the reception time, and adjust a recipe for beverages in the order to account for the change in quality. In yet another example, the components of the mesh network 600 at the vending location 620 can dynamically adjust a queue at the vending location 620 (e.g., to complete an order as close as possible to an estimated pick-up time). In yet another example, the components of the mesh network 600 at the vending location 620 can identify which beverage robots at the vending location 620 have the ingredients necessary to produce the order, and then assign the order (or portions thereof) to one of the eligible robots. The assignment can be based on which of the eligible robots can produce the order first, which of the eligible robots will produce the order closest to an estimated pick-up time, and/or the like. Additional examples of the functions of the components of the mesh network 600 are discussed below.

As illustrated in FIG. 6, the vending location 620 can include a POS system 624, an onsite computing system 626, and a network 630 of one or more beverage robots. The POS system 624 can be generally similar (or identical) to the POS system 224 discussed above with reference to FIG. 2. Purely by way of example, the POS system 224 can include an electronic register, a touchscreen device with a menu for the vending location 620, and/or the like. Similarly, the onsite computing system 626 can be generally similar (or identical) to the onsite computing system 226 discussed above with reference to FIG. 2. Purely by way of example, the onsite computing system 626 can include one or more onsite servers that provide a computational backbone for the vending location 620, provide additional storage for the vending location 620, and/or the like.

In the embodiment illustrated in FIG. 6, the network 630 includes three beverage robots. It will be understood, however, that the network 630 can include any other suitable number of beverage robots (e.g., one, two, three, five, ten, and/or any other suitable number of beverage robots). Any (or all) of the beverage robots in the network 630 can include a subsystem generally similar to the subsystem 400 discussed above with reference to FIG. 4 and/or can be generally similar to the beverage robot 500 discussed above with reference to FIG. 5. As a result, for example, each of the beverage robots in the network 630 can receive orders (or portions thereof) and/or automatically prepare beverages to produce the received orders. To help organize the production of orders, the network 630 can include designations for a primary robot 632 and two secondary robots 634 (referred to individually herein as a “first secondary robot 634A” and a “second secondary robot 634B”). The primary robot 632 (sometimes referred to herein as a “primary beverage robot,” a “leader robot,” and/or the like) can be communicably coupled to the remote system 610, the POS system 624, the onsite computing system 626, and each of the secondary robots 634 (sometimes also referred to herein as “secondary beverage robots,” “follower robots,” and/or the like). During operation, the primary robot 632 can receive orders (e.g., from the POS system 624, from the remote system 610, and/or the like), assign the orders (or portions thereof) among the beverage robots in the network 630, make one or more changes to the recipe(s) associated with beverage(s) in the order, publish information related to the order (e.g., a status of the order, a position of the beverages in a queue, estimated completion times, and/or the like), dynamically adjust queues at each of the beverage robots in the network 630, and/or the like.

For example, after receiving an order, the primary robot 632 can check the ingredients required for each beverage in the order (e.g., via an internal memory device, a query to the onsite computing system 626, one or more queries to the secondary robots 634, and/or a query to the remote system 610). The primary robot 632 can then determine which of the beverage robots is eligible to prepare one or more beverages in the order based on the ingredients. Additionally, or alternatively, the primary robot 632 can check its own available ingredients and can query each of the secondary robots 634 to provide a record of their available ingredients. The check can be useful, for example, to confirm that the eligible robots have a sufficient volume of the ingredients available to prepare the beverage(s) in the order.

Further, the primary robot 632 can determine an estimated wait time and/or an estimated time of completion at each of the eligible robots before assigning the order (or portions thereof) to the eligible robots. For example, the primary robot 632 can have a first queue of beverages that are already assigned to the primary robot 632. That is, the primary robot 632 will need to produce each of the beverages in the first queue before being able to prepare any beverage from a new order. The primary robot 632 can determine the estimated completion time for a beverage in a new order at the primary robot 632 based on an estimated preparation time for each of the beverages in the first queue plus an estimated preparation time for the beverage in the new order. In some embodiments, the estimated preparation time is based at least partially on an average preparation time per beverage (e.g., 20 seconds per beverage, 30 seconds per beverage, 40 seconds per beverage, 1 minute per beverage, and/or the like). In some embodiments, the estimated preparation time is based on preparation times specific to the beverages in the queue (e.g., 32 seconds for a first beverage, 25 seconds for a second beverage, 47 seconds for a third beverage, and/or the like). Similarly, the first secondary robot 634A can have a second queue of beverages that are already assigned to the first secondary robot 634A and the second secondary robot 634B can have a third queue of beverages that are already assigned to the second secondary robot 634B. In some embodiments, the estimated completion time is based at least partially on scheduled (or predicted) downtime at the eligible robots. The scheduled and/or predicted downtime can be for maintenance to the eligible robot, cleaning of the eligible robot, replacing ingredients at the eligible robot, and/or the like. As a result, for example, the primary robot 632 can determine the estimated completion time for the beverage in the new order at each of the first and second secondary robots 634A, 634B based on an estimated preparation time for each of the beverages in the second and third queues, respectively, plus an estimated preparation time for the beverage in the new order, plus any scheduled and/or predicted downtime.

In some embodiments, the primary robot 632 checks an estimated pick-up time and/or an estimated reception time associated with the order. The estimated pick-up time can be based on when the customer or a delivery person will arrive at the vending location 620. In a specific, non-limiting example, the primary robot 632 can check the order for a requested pick-up time to identify an estimated pick-up time. In another non-limiting example, the primary robot 632 can check a location of a user device associated with the order (e.g., via geographic information submitted through an app on a user's phone when submitting the order) to identify an estimated pick-up time (e.g., based on estimated travel time). The reception time can be based on when a customer will receive the beverage(s) in an order from a delivery person after the delivery person picks up the order from the vending location 620. In some such embodiments, the primary robot 632 assigns the order based on which of the eligible robots will complete the order closest to the estimated pick-up time to help improve a freshness of the order when it is actually picked up. Additionally, or alternatively, when the estimated pick-up time is far enough away, the primary robot 632 can pause the assignment of the order (and/or assign the order with instructions to pause) until closer to the estimated pick-up time. By selectively assigning and/or pausing the order, the primary robot 632 can improve the freshness of the order when it is actually picked up, thereby improving the quality of beverages in the order. Additionally, or alternatively, the primary robot 632 can, for each beverage in the order, adjust a recipe associated with the beverage to account for changes in quality between the estimated completion time and the estimated pick-up time/the estimated reception time. In a specific, non-limiting example, ice melting in a beverage between the estimated completion time and the estimated pick-up time can dilute a beverage and negatively impact a flavor profile of the beverage. To account for the dilution, the primary robot 632 can adjust a ratio of ingredients to water dispensed when preparing a beverage (e.g., increasing the volume of ingredients dispensed) to increase a concentration of the beverage at the completion time. As a result, the dilution from the ice melting can return the beverage to an intended concentration, thereby reducing the impact the gap between the completion time and the pick-up time has on the flavor profile of the beverage.

In some embodiments, the primary robot 632 checks an estimated completion time for portions of the order not prepared by the beverage robots in the network 630 (e.g., food items in the order) before assigning the order (or portions thereof) to the eligible robots. Similar to the discussion above, the check can allow the primary robot 632 to delay the order, assign the order to one of the eligible robots to help synchronize the preparation of beverages produced by the beverage robots with the other parts of the order, and/or adjust a recipe for the beverages to account for changes in the quality of the beverages. In turn, the synchronization and/or adjustment to the recipe can help improve a consistency in the flavor profile of the beverages produced by the beverage robots when they are received (e.g., by preventing the beverages produced by the beverage robots from sitting while the other portions of the order are produced and/or accounting for the time they are sitting).

Additionally, or alternatively, the primary robot 632 can make information about the queue at each of the beverage robots in the network 630 and/or the estimated completion times accessible to customers, delivery personnel, and/or staff at the vending location 620. The information can increase transparency on the status of an order to help improve customer satisfaction and/or temper expectations. Further, because the estimated completion time can be based on granular data (e.g., accurate preparation times for each beverage in the queue at the beverage robots), the estimated completion times can be more accurate than general estimates provided by conventional order management systems. The increase in accuracy can help increase customer satisfaction, allow delivery personnel to better plan delivery routes and/or schedule deliveries, and/or the like.

Although the processes related to receiving, assigning, and managing orders have been discussed as being executed by the primary robot 632, one of skill in the art will understand that the technology disclosed herein is not so limited. For example, the processes of receiving, adjusting, assigning, and managing orders can be executed by the onsite computing systems 626 (which can sometimes be designated as an onsite “virtual primary robot”). Receiving and assigning the orders from the onsite computing systems 626 can reduce the computational power required in any of the beverage robots. In another example, the process of receiving and assigning orders can be executed by the remote system 610 (which can sometimes be designated as a cloud-implemented “virtual primary robot”) and relayed to the beverage robots through a network communication system. Further, the beverage robot assigned as the primary robot 632 does not necessarily remain constant. For example, because any of the beverage robots can include a platform generally similar to the subsystem 400 (and the platform 410 therein) discussed above with reference to FIG. 4, any of the beverage robots can be designated as the primary robot. The non-permanent designation can be useful, for example, to allow a beverage robot currently designated as the primary robot to undergo maintenance procedures while one of the beverage robots designated as a secondary robot is promoted to the primary robot designation.

As further illustrated in FIG. 6, various components of the mesh network 600 can be communicably coupled to a client computing device 640 associated with a user (e.g., customer, delivery person, and/or the like). For example, the client computing device 640 can be communicably coupled to the remote system 610 to place an order for one or more beverages, provide a desired pickup time, and/or provide a real-time geographic location information. The client computing device 640 can be generally similar (or identical) to the client computing device 230 discussed above with reference to FIG. 2. The remote system 610 can then communicate with any suitable component of the vending location 620 (e.g., the POS system 624, the onsite computing system 626, and/or the network 630 of beverage robots) to provide information related to the order. Further, the remote system 610 can receive updates related to a status of the order, a queue at the beverage robots, the estimated completion time for the order and/or any individual beverage in the order, the current step of the preparation of any of the beverages in the order, and/or the like and relay the updates to the client computing device 640.

Additionally, or alternatively, the client computing device 640 can communicate directly with various components of the vending location 620 (e.g., the POS system 624, the onsite computing system 626, and/or the network 630 of beverage robots) to place the order and/or receive updates related to the order. For example, a customer can access a website associated with the vending location 620 and/or a mobile application associated with the vending location 620 through the client computing device 640 to place an online to the vending location 620. The website, delivery app, and/or restaurant app can then provide the order to the POS system 624. The POS system 624 can receive the order and relay the order to the network 630 of beverage robots, along with information related to the order (e.g., customizations to the beverage(s) in the order, whether the order is for an in-person pickup, dining at the vending location 620, delivery order to a remote customer, the time of pickup, an estimated delivery time between the vending location 620 and the customer, any beverage or customer related information, and/or the like). The primary robot 632 (and/or the secondary robots 634) can use the information related to the order to dynamically adjust recipe ratios of the beverage(s) (e.g., based on the delivery location), adjust the preparation time of the beverage(s) (e.g., based on the customer pickup time and/or the ingredients in the beverage), adjust the placement of the order in their queues (e.g., based on the customer location information and/or the ingredients in the beverage), and/or the like. The primary robot 632 can then provide information to the POS system 624 related to the status of the order (e.g., information on the queue, an accurate estimation of the completion time, and/or the like). In some embodiments, the client computing device 640 executes a third-party food/beverage delivery application that is integrated with the vending location 620 to place the order. By integrating the third-party delivery applications with the vending location 620 (e.g., via the POS system 624 and/or the onsite computing system 626), the network 630 of beverage robots can provide real-time progress updates to the third-party platforms and/or the user accessing the third-party platforms. Additionally, or alternatively, the integration can allow the third-party platform to share information with the vending location 620, such as a GPS location of the client computing device 640, to allow the vending location to adjust a recipe for the beverages, dynamically adjust the queue at the beverage robots, and/or the like.

While an order is in production, the client computing device 640 can receive real-time beverage preparation times or delivery time estimates from the vending location 620 and/or the remote system 610. The real-time information enhances transparency and reliability in the delivery process, allowing consumers to accurately track their orders, thereby reducing uncertainties and frustrations associated with inaccurate wait time estimations. For example, the real-time information can provide food and beverage preparation visibility to the consumer and/or the delivery persons to assist in managing arrival times and/or delivery routes. In a specific, non-limiting example, the real-time information can help customers arrive at the vending location 620 closer to the actual completion time for their order (e.g., as compared to a generic, uninformed estimate), which can help increase a freshness of the food and/or beverages when they are received. Additionally, or alternatively, the client computing devices can communicate with the network 630 of beverage robots (e.g., through the remote system 610, through the POS system 624, and/or directly) to provide information about travel times and/or delivery routes. As a result, the network 630 of beverage robots can adjust preparation timing of beverages to maintain the freshness of the beverage for the customer. For example, when the consumer or the delivery partner is delayed from picking up an ordered beverage from the vending location 620, the network 630 of beverage robots can hold the ordered item in the queue and wait until the customer or delivery partner is within a threshold distance of the vending location 620. Additional details on various processes related to receiving, assigning, producing, and/or managing the orders, and associated systems and methods, are discussed below with reference to FIGS. 8-11.

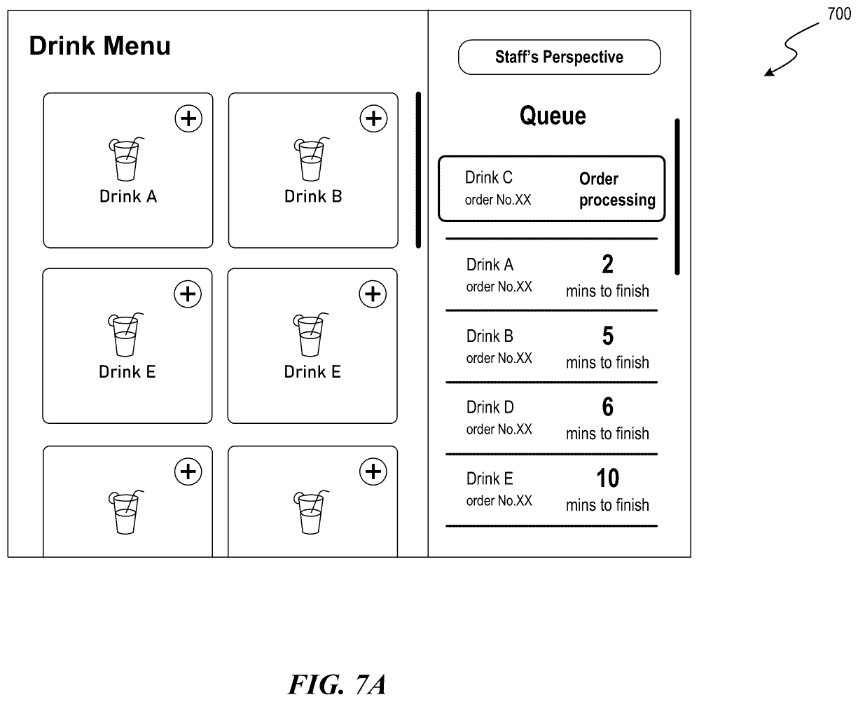

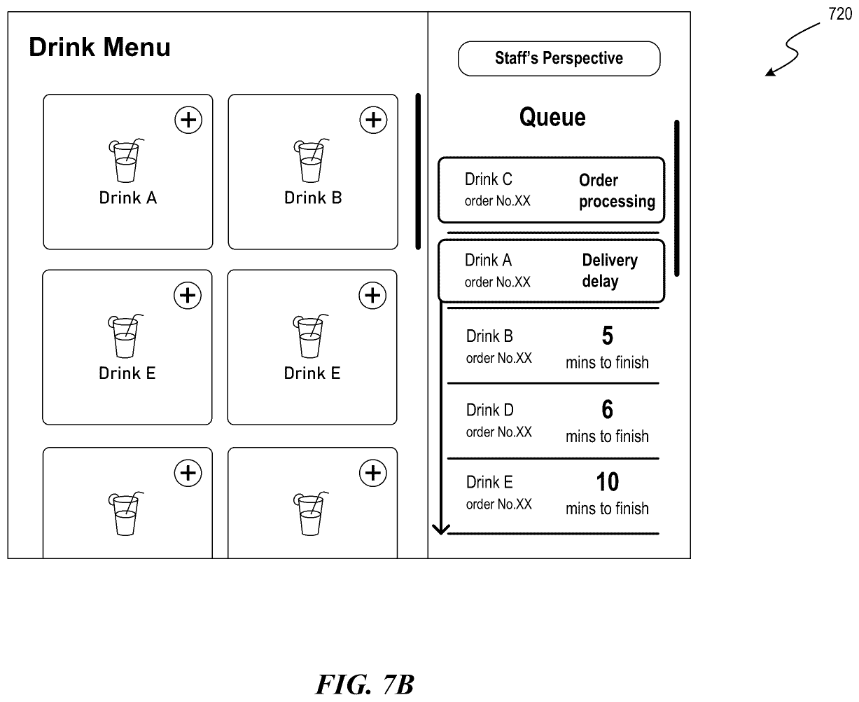

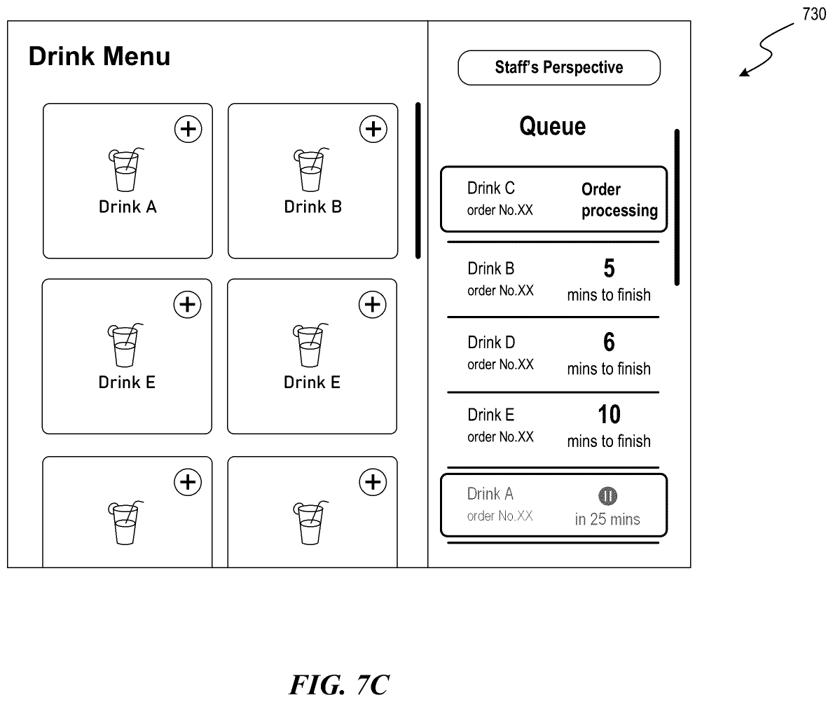

Various components of the mesh network 600 (and/or devices communicatively coupled thereto) can display beverage information (e.g., a menu for the vending location to start a new order, beverages in a queue, and/or the like), to a staff at the vending location 620. FIG. 7A is a wireframe diagram illustrating an example of a first user interface 700 displaying order information in accordance with some embodiments of the present technology. The first user interface 700 can be displayed, for example, to staff of a vending location via a POS system, on one or more of the beverage robots, on a screen of the onsite computing system, and/or any other suitable location. In the illustrated embodiment, the beverage information includes a drink menu, a queue of ordered beverages, and the time remaining until each beverage in the queue is prepared. The time remaining for each beverage can be based on an average preparation time per beverage and/or preparation times specific to each beverage. For example, the first user interface 700 displays that the status of drink C is “order processing,” the status of drink A is “2 mins to finish,” the status of drink B is “5 mins to finish,” the status of drink D is “6 mins to finish,” and the status of drink E is “10 mins to finish.” Although the first user interface 700 is indicated to be the order information from the perspective of staff at the vending location, it will be understood that a similar (or identical) user interface can be available to customers, delivery personnel, and/or any other suitable person associated with orders placed at the vending location. Purely by way of example, a similar (or identical) user interface can be provided to the client computing device 640 of FIG. 6 to provide information to a customer related to their order.

FIG. 7B is a wireframe diagram illustrating an example of a second user interface 720 displaying beverage information in accordance with further embodiments of the present technology. The beverage information can include a drink menu for the vending location, a queue of ordered beverages, the time remaining until each beverage in the queue is prepared, and/or one or more errors in the queue. In the example of FIG. 7B, the second user interface 720 displays that the status of drink C is “order processing,” the status of drink A is “delivery delay,” the status of drink B is “5 mins to finish,” the status of drink D is “6 mins to finish,” and the status of drink E is “10 mins to finish.” The delivery delay of drink A can be based on one or more ingredients being out of stock at the relevant beverage robot, required maintenance at the beverage robot, a pause requested by the staff at the vending location and/or anyone else associated with the order, and/or the like. In some embodiments, the second user interface 720 can allow a user to select drink A to see more information on the delivery delay (e.g., an explanation for the delay, information on how to cure the error, and/or the like). Similar to the discussion above, although the second user interface 720 is indicated to be the order information from the perspective of staff at the vending location, it will be understood that a similar (or identical) user interface can be available to customers, delivery personnel, and/or any other suitable person associated with orders placed at the vending location.

FIG. 7C is a wireframe diagram illustrating an example of a third user interface 730 displaying beverage information in accordance with some embodiments of the present technology. The beverage information can include a drink menu, a queue of ordered beverages, the time remaining until the beverage is prepared, and/or a status of one or more beverages in the queue. In the example of FIG. 7C, the third user interface 730 displays that the status of drink C is “order processing,” the status of drink B is “5 mins to finish,” the status of drink D is “6 mins to finish,” and the status of drink E is “10 mins to finish,” and the status of drink A is “paused, prepare in 25 mins.” The pause to the preparation of drink A can be based on a requested pick up time, a detection that the customer and/or delivery driver will not arrive for at least 25 minutes (e.g., based on geographic information), a status of other items in the order, and/or the like. In some embodiments, the third user interface 730 can allow a user to select drink A to see more information on the paused production (e.g., an explanation for the pause). Additionally, or alternatively, the third user interface 730 can allow a user to override the pause (e.g., allowing the staff at the vending location to accelerate the preparation of drink A when a customer arrives ahead of their requested pick-up time). In some embodiments, the status of a beverage in the queue includes an indication that the recipe for the beverage has been altered. The alterations can be based on customizations received with an order, expected delays between the completion time and the reception time, and/or the like. In such embodiments, the third user interface 730 can allow a user to select the altered beverage to view the alterations, change/undo the alterations, and/or make additional alterations.

Similar to the discussion above, although the third user interface 730 is indicated to be the order information from the perspective of staff at the vending location, it will be understood that a similar (or identical) user interface can be available to customers, delivery personnel, and/or any other suitable person associated with orders placed at the vending location. Further, although various specific examples have been illustrated and discussed with reference to FIGS. 7A-7C, it will be understood that the technology is not so limited. For example, the mesh networks disclosed herein can include a user interface with any combination of the features illustrated and discussed with reference to FIGS. 7A-7C.

FIG. 8 is a flow diagram of a process 800 for operating a mesh network with a plurality of beverage robots in accordance with some embodiments of the present technology. The mesh network can be generally similar to the mesh network 600 discussed above with reference to FIG. 6. Further, it will be understood that the process 800 can be executed by any suitable computing devices in the mesh network. For example, the process 800 can be executed by a computing device housing the platform 300 discussed above with reference to FIG. 3; the subsystem 400 discussed above with reference to FIG. 4; the remote system 610, POS system 624, the onsite computing system 626, and/or the primary robot 632 discussed above with reference to FIG. 6; and/or the like. Additionally, or alternatively, although discussed herein in the context of being executed entirely within a single component (e.g., entirely within the primary robot 632 and/or the remote system 610 of FIG. 6), it will be understood that one or more steps in the process 800 can be executed by a different computing device than one or more other steps.

As illustrated in FIG. 8, the process 800 can begin at block 802 by receiving an order. The order can be received from a POS system (e.g., a register, electronic kiosk, electronic terminal, and/or the like), a remote system (e.g., a cloud system coupled to an app for a mobile device, a web-based POS, and/or the like), and/or any other suitable system. The order can include one or more beverages to be prepared by beverage robots in the mesh network. Each of the beverages is associated with a recipe that requires one or more ingredients (e.g., concentrated juices, syrups, coffee, tea, and/or the like; water; sparkling and/or carbonated water; milk and/or milk alternatives; and/or the like).

At block 804, the process 800 includes checking the ingredients available at each beverage robot in the mesh network to determine a list of eligible robot(s) available to help produce the order. To be available to help produce the order, a beverage robot must have the ingredients required for one or more of the beverage(s) in the order. Accordingly, checking the ingredients available at each beverage robot in the mesh network to determine the list of eligible robots can include identifying the ingredients required for each beverage in the order (e.g., based on the recipe for each beverage and/or any modifications in the order). Identifying the required ingredients can include retrieving a list of recipes from a central database (e.g., a storage device in the primary robot, at the remote system, and/or the like), another database (e.g., querying an onsite computing system) for the recipes, and/or one or more of the beverage robots in the mesh network. Similarly, checking the ingredients available at each of the beverage robot(s) can include retrieving a list of ingredients available (e.g., in stock, stored, etc.) at each beverage robot in a central database, querying another database for the list, and/or querying each of the beverage robots in the mesh network. The process 800 at block 804 can then review the ingredients available at each of the beverage robots to identify eligible robots that are available to prepare at least one beverage (or all beverages) in the order.

At decision block 806, the process 800 if no matches were identified for one or more items in the order (e.g., eligible robots available to prepare the item(s)) the process 800 continues to block 808. If one or more matches were identified, the process 800 continues to block 810.

At block 808, the process 800 returns the order to a POS system, a remote system, and/or any other suitable destination. The return can identify that none of the beverage robots are available to help produce the order. For example, when an order is for food items, canned/bottled beverages, and/or the like, the beverage robots will not be available to help produce any portion of the order. In this example, the return confirms (e.g., to the POS system and/or another suitable endpoint) that the beverage robots will not take any action. Additionally, or alternatively, the return can indicate an error with the order prompting the POS system (or other suitable component) to make one or more changes to the order and/or refund the customer for a portion of the order. For example, the error can indicate that one or more ingredients are out of stock at the vending location and the return can prompt the POS system to request a change to the order and/or refund the portion of the order requiring the out-of-stock ingredients. In another example, the error can indicate that one or more ingredients need to be replaced in the beverage robots (e.g., by replacing one or more BIB systems) before the order can be produced.

At block 810, the process 800 includes determining various timing-related parameters for the order. The timing-related parameters can include an estimated pick-up time for the order, an order type, an order priority, and/or the like. As discussed above, determining the estimated pick-up time can include checking for a requested pick-up time in the order (e.g., pick-up in 1 hour, pick-up at 1:30 PM, and/or the like). Additionally, or alternatively, determining the estimated pick-up time can include checking the location of a user device associated with the order (e.g., via geographic information submitted through an app) and calculating an estimated travel time to the vending location. The user can be the customer, a delivery person, and/or any other suitable person. The order type (e.g., whether the order is in person, a mobile order, whether there are other items in the order, and/or the like) can impact the timing of when beverages in an order should be produced to help maximize the freshness of the beverages at an actual reception time for the beverages. Purely by way of example, in-person orders can be produced immediately while mobile orders are delayed. In another example, orders associated with food items can be delayed and completed closer to the completion of the food items. The order priority can allow an order to be expedited (e.g., to expedite a replacement for an incorrect order), allow various orders to be prioritized over others (e.g., prioritizing beverage-only orders over beverage-and-food orders), and/or the like.

At block 812, the process 800 includes checking a queue at each of the eligible robots (e.g., each of the robots identified as available in block 804). The queue can include the number of beverages already assigned to each of the eligible robots to be prepared by each of the individual eligible robots. Additionally, or alternatively the queue can include information about the orders associated with the queues, information about the individual beverages in the queue, required downtime at the eligible robots (e.g., for cleaning, maintenance, and/or ingredient replacement), and/or the like. In various embodiments, checking the queue(s) can include accessing a central database that maintains current information on the queue(s), querying another database for the queue(s), and/or querying each of the beverage robots in the mesh network.

At decision block 814, the process 800 determines whether to schedule the order now (e.g., by assigning the beverage(s) in the order to one or more beverage robots, placing the beverage(s) in the corresponding queue(s)). The determination at decision block 814 can be based on the timing-related parameters from block 810 and/or estimated completion times for the order based on the queue(s) from block 812 (e.g., an estimated completion time for each eligible robot). Purely by way of example, an in-person, beverage-only order can be scheduled immediately while a mobile order with a scheduled pick-up time can be delayed.

If the process 800 decides not to schedule the order now at decision block 814, the process 800 moves to block 816 to pause the order; else the process 800 moves to block 818. After the pause, the process 800 can return to block 812 to check the queue(s) at the eligible robot(s) again or proceed directly to block 818. In some embodiments, for example, the process 800 at decision block 814 pauses the production of the order for a predetermined amount of time (e.g., 30 seconds, 1 minute, 5 minutes, 10 minutes, 30 minutes, and/or any other suitable amount of time). In another example, the process 800 can pause the production of the order until closer to the estimated pick-up time, the estimated completion time for other item(s) in the order, and/or the like. In yet another example, the process 800 can pause the production of the order until a condition to resume is received (e.g., a determination that the user is within a predetermined distance and/or travel time from the vending location, an indication that other item(s) in the order are complete, and/or the like).

At block 818, the process 800 includes determining a chosen robot from the eligible robots to produce the order (or prepare any suitable subset of the beverages in the order). The determination of the chosen robot can be based on which of the eligible robots can prepare one or more of the beverage(s) in the order fastest. For example, the determination can identify the eligible robots with the shortest queue(s) and assign them one or more of the beverages from the order. Additionally, or alternatively, the determination can be based on the timing-related parameters from block 810. For example, the process 800 can choose an eligible robot with a longer queue for a low-priority order (e.g., a mobile order) to intentionally delay the production of the order. As a result, the order can be fresher when it is actually picked up. Further, eligible robots with shorter queues remain more quickly available for high-priority orders (e.g., in-store orders), which can help increase throughput and customer satisfaction, and can help manage traffic in the vending location. In another example, the process 800 can choose based on which of the eligible robots will be least impacted by promoting an order associated with a high priority (e.g., replacing an incorrect order) to the top of the queue.

At block 820, the process 800 includes assigning the order (or any suitable subset of the beverages in the order) to the chosen robot. As a result, the chosen robot can add the beverages in the assignment to the corresponding queue and prepare the assigned beverages after preparing any beverages that were already in the queue. The assignment at block 820 can include sending (e.g., transmitting) the order (or any suitable subset of the order) to the chosen robot. Additionally, the assignment can include sending an indication of the assignment to any other suitable destination. For example, the assignment at block 820 can include updating the database in the primary robot to update the queue corresponding to the chosen robot. In another example, the assignment at block 820 can include sending the assignment to the POS system, the onsite computing devices, and/or the remote system to update queues stored therein, update a status of the order visible to a customer associated with the order, and/or the like. In some embodiments, the assignment at block 820 places the order (or any suitable subset of the order) at the back of the queue at the chosen robot. In some embodiments, the assignment at block 820 places the order higher on the queue at the chosen robot (e.g., to expedite an order with a high priority). In a specific, non-limiting example, an order identified as replacing an incorrect order at block 810 can be placed at the front of the queue at the chosen robot by the assignment at block 820.

At block 822, the process 800 includes determining the status of the order for a customer. The status can include how many beverages are ahead of the order at each of the chosen robots, an estimated time of completion for the order based on the queues at each of the chosen robots, and/or the like. The status can be retrieved from the assigned robot and stored in a database at the primary robot, the POS system, the onsite computing devices, and/or the remote system.

At decision block 824, the process 800 includes making the status of the order available to the customer (and/or any other suitable person). For example, the status can be accessible through the POS system, an app, a web browser, and/or the like and/or otherwise visible to customers and/or other users (e.g., delivery drivers, vending location personnel, and/or the like). In some embodiments, the status is presented on an electronic display at the vending location. Because the status is constantly updated, the status can provide a customer with clarity on how many orders are in front of them and a dynamically updated, accurate estimation of the completion time. The increased transparency can, in turn, help create a positive experience for the customer, particularly during periods with longer wait times (e.g., periods with high demand). Further, the accurate estimation of the completion time can help the customer (or a delivery person) optimize their route to reduce idle time waiting for the order in the vending location and/or to help reduce the amount of time between the beverages being completed and the beverages being picked-up.

At block 826, the process 800 completes the order. Completing the order can include prompting vending location personnel to deliver the order to the customer (or other suitable person), cleansing one or more components of the chosen beverage robot(s), and/or resetting the chosen beverage robot(s) for the next order. Additionally, or alternatively, completing the order can include updating the queue(s) at the chosen robot(s) to remove the beverage(s) assigned to them and/or updating the record to reflect the completed orders. Records of the completed orders can be stored on a database at the primary robot, the POS system, the onsite computing devices, and/or the remote system for future reference (e.g., to review sales trends, common modifications to recipes, popular drinks, periods of high demand, transaction history, mileage for the beverage robots, and/or the like).

Although the blocks 802-826 of the process 800 are discussed and illustrated in a particular order, the process 800 illustrated in FIG. 8 is not so limited. For example, various steps of the process 800 can be performed in a different order. In these and other embodiments, any of the blocks 802-826 of the process 800 can be performed before, during, and/or after any of the other blocks 802-826 of the process 800. In a specific, non-limiting example, all or a subset of the blocks 814-816 can be executed before executing block 812 to decide whether to prepare a beverage before checking the queues at the eligible beverage robots. The switch can be useful, for example, when assuming an average preparation time for the beverage(s) in the order and identifying that the estimated pick-up time is more than a predetermined period after an estimated completion time based on the average preparation time. In another specific, non-limiting example, all or a subset of blocks 814-816 can be performed after (or at the same time as) executing all or a subset of blocks 818-820. That is, the process 800 can assign the order (or portions thereof) to one or more beverage robots before (or while) determining whether to pause the production of the order until closer to the estimated pick-up time. Moreover, a person of ordinary skill in the relevant art will recognize that the illustrated process 800 can be altered and still remain within these and other embodiments of the present technology. For example, the process 800 can be modified in view of any of the processes discussed below with reference to FIGS. 9-11.

FIG. 9 is a flow diagram of a process 900 for operating a mesh network to communicate with a third-party ordering platform in accordance with some embodiments of the present technology. The mesh network can be generally similar to the mesh network 600 discussed above with reference to FIG. 6. Further, it will be understood that the process 900 can be executed by any suitable computing devices in the mesh network. For example, the process 900 can be executed by a computing device housing the platform 300 discussed above with reference to FIG. 3; the subsystem 400 discussed above with reference to FIG. 4; the remote system 610, POS system 624, the onsite computing system 626, and/or the primary robot 632 discussed above with reference to FIG. 6; and/or the like. Additionally, or alternatively, although discussed herein in the context of being executed entirely within a single component (e.g., entirely within the primary robot 632 of FIG. 6), it will be understood that one or more steps in the process 900 can be executed by a different computing device than one or more other steps. The process 900 can be executed, for example, by a POS system integrated with a third-party ordering platform (e.g., a delivery app) to confirm delivery times and/or to provide real-time progress updates to consumers and the third-party ordering platform.

As illustrated in FIG. 9, the process 900 can begin at block 902 by receiving an order. The order can be received from an in-store POS system, a remote system (e.g., a cloud system coupled to an app for a mobile device, a web-based POS, and/or the like), or any other suitable system. The order can include one or more beverages to be prepared by beverage robots in the mesh network. Each of the beverages is associated with a recipe that requires one or more ingredients (e.g., concentrated juices, syrups, coffee, tea, and/or the like; water; sparkling and/or carbonated water; milk and/or milk alternatives; and/or the like).

At block 904, the process 900 includes processing the order. Processing the order at block 904 can be generally similar (or identical) to the steps described at blocks 804-820 of FIG. 8 (or any subset thereof) to determine which of the beverage robots to assign the order to. At block 906, the process 900 includes determining the status of the order for a customer. The status can include how many beverages are ahead of the beverage(s) in the order at each of the chosen robots, an estimated time of completion for the order based on the beverages in the queues at each of the chosen robots, an estimated reception time based on the estimated completion time and an estimated delivery time, and/or the like. The status can be retrieved from a database at the primary robot, the POS system, the onsite computing devices, and/or the remote system.

At block 908, the process 900 includes making the status of the order available to the customer (and/or other users such as delivery drivers, vending location personnel, and/or the like). The process 900 can make the status available through the POS system, the third-party ordering platform (e.g., an app on a user's device), a web browser, and/or any other suitable platform. In some embodiments, the status is presented on an electronic display at the vending location. Because the status is constantly updated, the status can provide a customer with clarity on how many orders are in front of them, the estimated completion time, and/or the like. The increased transparency can, in turn, help create a positive experience for the customer, particularly during periods with longer wait times (e.g., periods with high demand).

At decision block 910, the process 900 includes determining whether the customer approves completion of the order after reviewing the status of the order. The determination at decision block 910 can be based on one or more inputs received from the customer (e.g., directly to an in-store POS system, provided to the POS system a remote system and/or a third-party ordering platform, and/or the like). Purely by way of example, a customer can review the status of the order through a mobile app and select whether to proceed with the order, find a different vending location to complete the order, or modify and/or cancel the order. In a specific, non-limiting example, the customer can cancel an order due to a wait time at the vending location.

If the customer does not approve the completion of the order, the process 900 moves to block 912 to cancel (or modify) the order; else the process 900 moves to block 914. In some embodiments, when the customer cancels an order, the customer is presented with one or more alternate vending locations (e.g., other vending locations with beverage robots available to prepare the beverages) that can produce the order. The presentation can include an estimation of the completion time at and/or reception time from each of the alternative vending locations, a location of the alternative vending locations, estimated travel times to the alternative vending locations, reviews at the alternative vending locations, and/or the like.

At block 914, the process 900 includes sending an estimated pick-up time for the order to a delivery person and/or the customer. As discussed above, the estimated pick-up time can be a requested pick-up time in the order (e.g., pick-up in 1 hour, pick-up at 1:30 PM, and/or the like). Additionally, or alternatively, the estimated pick-up time can be based on the estimated completion time for the order (e.g., indicating the earliest time the order will be available for pick up). Additionally, or alternatively, the estimated pick-up time can be based on the location of a user device of the delivery person associated with the order (e.g., via geographic information submitted through an app) and calculating an estimated travel time to the vending location.

At block 916, the process 900 includes producing the order. Producing the order can include preparing each of the beverage(s) in the order at beverage robot(s) chosen for the beverage(s), prompting vending location personnel to deliver the order to the customer or the delivery person (or any other suitable person), cleansing one or more components of the chosen beverage robot(s), and/or resetting the chosen beverage robot(s) for the next order. Additionally, or alternatively, completing the order can include updating the queue(s) at the chosen robot(s) to remove the beverage(s) assigned to them and/or updating the record to reflect the completed orders. Records of the completed orders can be stored on a database at the primary robot, the POS system, the onsite computing devices, and/or the remote system for future reference (e.g., to review sales trends, common modifications to recipes, popular drinks, periods of high demand, transaction history, mileage for the beverage robots, and/or the like).

At block 918, the process 900 includes sending a notification to the delivery person and/or the customer that the order is completed. The notification can be displayed, for example, via a mobile app of the third-party delivery platform. Providing order preparation visibility to the consumer and the delivery person can help manage expectations from the customer and/or the delivery person. As a result, customers can have increased satisfaction when ordering from the vending location. Further, the increased visibility into the order production and/or the order status can help increase the freshness of the order when received by the customer. The robotic system can adjust the timing to prepare the order to maintain the freshness of the food and beverage of the order. For example, when the delivery person is far away from the vending location, the robotic system can hold the order in the queue and wait until the delivery person is within a proximity to the vending location.

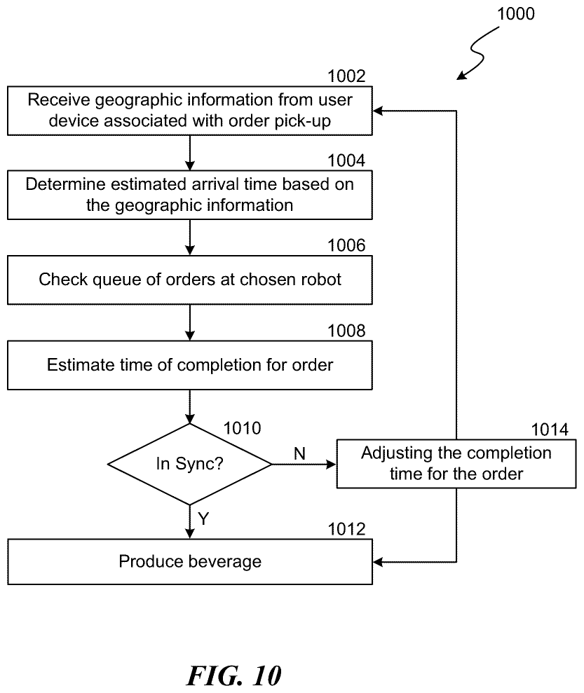

FIG. 10 is a flow diagram of a process 1000 for timing orders in production at a plurality of beverage robots in accordance with some embodiments of the present technology. More specifically, the process 1000 illustrated in FIG. 10 can be executed to help synchronize the production of orders with the arrival of various users (e.g., customers, delivery personnel, and/or the like) at a vending location. Similar to the processes discussed above with reference to FIGS. 8 and 9, the process 1000 can be executed by any suitable computing device (or combination of computing devices) in a mesh network of the type discussed above. Purely by way of example, the process 1000 (or any suitable portion thereof) can be executed by a computing device housing the platform 300 discussed above with reference to FIG. 3; the subsystem 400 discussed above with reference to FIG. 4; and/or any of the components of the mesh network 600 discussed above with reference to FIG. 6. Further, it will be understood that the process 1000 (and/or a generally similar process) can be executed as a part of and/or after the processes discussed above. Purely by way of example, the primary robot 632 and/or the remote system 610 of FIG. 6 can execute the process 1000 after assigning an order (or portions thereof) to a beverage robot at block 820 of FIG. 8, can execute the process 1000 as part of block 810 of FIG. 8 before determining a chosen robot, and/or the like.

The process 1000 begins at block 1002 by receiving geographic information from a user device associated with an order pick-up. The user device can be a smartphone of a customer, a delivery person, and/or the like. The geographic information can be received as part of an order (e.g., shared by the user device when submitting a mobile order), continuously (or periodically) after receiving the order (e.g., from an app on the smartphone), as part of an assignment of the order to a delivery person, and/or the like. The geographic information can include GPS data (and/or other suitable data) indicating the location of the user device, information on how the associated user is traveling (e.g., walking, biking, driving, riding transit, and/or the like), and/or any information on a planned route to the vending location (e.g., including any stops a delivery person will make on the way).

At block 1004, the process 1000 includes determining an estimated arrival time based on the geographic information. The estimated arrival time can represent an estimated actual pick-up time for the order, which can be significantly after an order is received (e.g., and therefore significantly after an order will be completed if produced immediately). Determining the estimated arrival time can include generating a route between the location of the user device and the vending location based on various modes of travel, determining traffic information, and estimating travel time on the route. Additionally, or alternatively, determining the estimated travel time can include referencing average travel times along the route between the user device and the vending location.

At block 1006, the process 1000 includes checking a queue of orders at the chosen robot for each beverage in the order. Similar to the discussion above, checking the queue at the chosen robot can include accessing a central, updated database (e.g., at the primary robot, at the remote system, and/or the like), querying another database for the queue (e.g., the POS system, onsite computing system, and/or the like), and/or querying the chosen robots for the most current queue.

At block 1008, the process 1000 includes estimating a time of completion for each beverage in the order (and/or the order overall) based on the queue information from block 1006. As discussed above, the estimated completion time can be based on an estimated preparation time for each of the beverages in the queue(s) plus an estimated preparation time for the beverage(s) in the order. In various embodiments, the estimated preparation time can be based on an average preparation time per beverage, preparation times specific to the beverages in the queue(s), planned downtime at the beverage robot(s) (e.g., for maintenance, cleaning, ingredient replacement, and/or the like), and/or the like.

At decision block 1010, if the estimated completion time is generally in sync with the estimated arrival time (e.g., the estimated pick-up time), the process 1000 continues to block 1012 to produce the beverage(s) at the chosen robot. In various embodiments, for the process 1000 to consider the estimated completion time to be generally in sync with the estimated arrival time, the estimated completion time must be within 1 minute, within 2 minutes, within 5 minutes, within 10 minutes, within 15 minutes, and/or within any other suitable period of the estimated arrival time.

Conversely, if the estimated completion time is not generally in sync with the estimated arrival time, the process 1000 continues to block 1014 to adjust a completion time for the order. Adjusting the completion time for the order can include pause the production of the order and/or adjust a queue at the chosen beverage robot. Similar to the discussion above, the pause can be for a predetermined amount of time (e.g., 30 seconds, 1 minute, 5 minutes, 10 minutes, 30 minutes, and/or any other suitable amount of time), until closer to the estimated arrival time, until a condition to resume is received (e.g., a determination that the user is within a predetermined distance and/or travel time from the vending location), and/or the like. Accordingly, for example, the process 1000 can return to block 1002 after pausing the production of the order to receive (or check) for updated geographic information from the user device, determine an updated estimated time of arrival, check the queue(s) at the chosen robot(s), and/or estimate a new time of completion for the order. Additionally, or alternatively, the process 1000 can adjust the queue at the chosen robot. In some embodiments, the adjustment delays the preparation of the beverage(s) to help synchronize the completion time with the time of arrival. In some embodiments, the adjustment expedites the beverage(s) ahead of one or more other beverages in the queue. The adjustment can be based on a priority of the beverage, availability of the ingredients in the beverage, a determination that the customer for a first order will arrive before the delivery person for a second order (e.g., to produce the first order quicker), a determination that the order was paused for too long (e.g., in response to a determination, after the pause, that the customer will arrive before the beverage(s) are complete), and/or the like.

The process 1000 can then repeat these steps any suitable number of times until the estimated time of completion is generally in sync with the estimated time of arrival. It will be understood, however, that the process 1000 can skip any of the steps discussed above during the loop. Purely by way of example, the process 1000 can use the original estimated time of arrival for each loop (e.g., skipping block 1002 and block 1004) to avoid needing to repeatedly receive geographic information from the user device. Further, in some embodiments, the process 1000 places the order back into the queue after the pause, without re-evaluating the estimated time of completion and the estimated arrival time. By adjusting the order priority in the queue to sync with the estimated time of pick-up based on the real-time location of the user picking up the order, process 1000 can ensure the beverage is served shortly after the beverage is prepared to maintain quality for the customer.

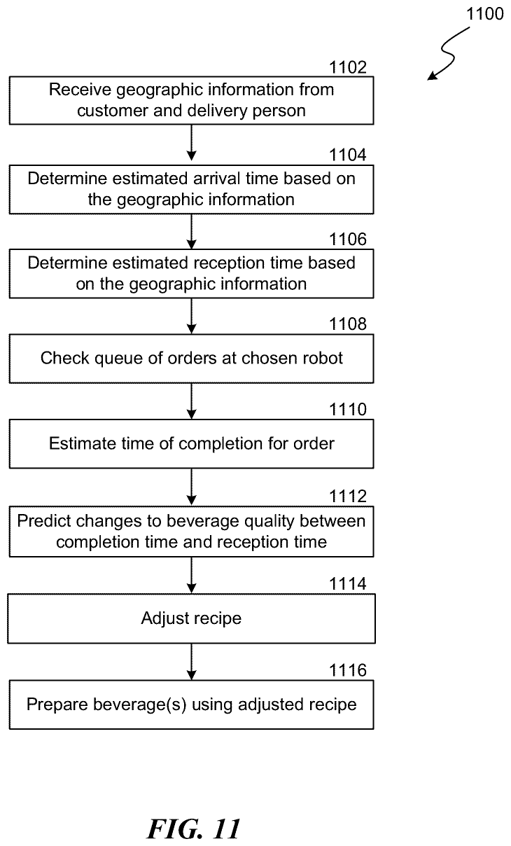

Although the blocks 1002-1012 of the process 1000 are discussed and illustrated in a particular order, the process 1000 illustrated in FIG. 10 is not so limited. For example, various steps of the process 1000 can be performed in a different order. In these and other embodiments, any of the blocks 1002-1012 of the process 1000 can be performed before, during, and/or after any of the other blocks 1002-1012 of the process 1000. In a specific, non-limiting example, all or a subset of the blocks 1006-1008 can be executed before executing the blocks 1002-1004 estimate a completion time for the order before (or while) determining an estimated arrival time for the user associated with the order. In another specific, non-limiting example, block 1014 can be executed before executing any of blocks 1002-1012 when an order is received with a requested pick up time that is more than a predetermined time in the future (e.g., more than 30 minutes away, more than 1 hour away, and/or the like). Moreover, a person of ordinary skill in the relevant art will recognize that the illustrated process 1000 can be altered and still remain within these and other embodiments of the present technology. For example, the process 1000 can be integrated into any of the processes discussed above with reference to FIGS. 8 and 9. Additionally, or alternatively, the process 1000 can be modified in view of the process 1100 discussed below with reference to FIG. 11. In a specific, non-limiting example, the process 1000 at block 1014 (e.g., in response to a decision that the estimated arrival time and estimated completion time are not in sync) can modify a recipe for the beverage(s) in the order based on the process 1100 discussed in more detail below.

FIG. 11 is a flow diagram of a process 1100 for adjusting recipe ratios of orders in production at a plurality of beverage robots in accordance with some embodiments of the present technology. More specifically, the process 1100 illustrated in FIG. 11 can be executed to help prevent dilution of a beverage due to ice melting during a delivery to a customer at a remote location from the vending location. Similar to the processes discussed above with reference to FIGS. 8-10, the process 1100 can be executed by any suitable computing device (or combination of computing devices) in a mesh network of the type discussed above. Purely by way of example, the process 1100 (or any suitable portion thereof) can be executed by a computing device housing the platform 300 discussed above with reference to FIG. 3; the subsystem 400 discussed above with reference to FIG. 4; and/or any of the components of the mesh network 600 discussed above with reference to FIG. 6. Further, it will be understood that the process 1000 (and/or a generally similar process) can be executed as a part of and/or after the processes discussed above. Purely by way of example, the primary robot 632 and/or the remote system 610 of FIG. 6 can execute the process 1100 after assigning an order (or portions thereof) to a beverage robot at block 820 of FIG. 8, can execute the process 1100 as part of block 810 of FIG. 8 before determining a chosen robot, and/or the like.

The process 1100 begins at block 1102 by receiving geographic information from a customer associated with the order and/or a delivery person associated with the order. The geographic information from the customer can be associated with a delivery location for the order. In some embodiments, the delivery location is a real-time location associated with the user device. In some embodiments, the delivery location is a location manually entered and/or selected by the customer. Additionally, or alternatively, the geographic information can be received from the user device (e.g., a smartphone, computer, and/or the like) of the customer placing the order and/or the delivery person assigned to the order. The geographic information can be received as part of an order (e.g., shared by the user device when submitting the order) and/or as a separate message when a delivery person is assigned to the order. The geographic information can include GPS data (and/or other data) indicating the location of the user device, a delivery location and/or delivery address, and/or any information on a planned route from the vending location (e.g., including any stops a delivery person will make on the way) to the customer's requested delivery location (e.g., residence, workplace, etc.). Additionally, or alternatively, the geographic information can include GPS data indicating a location of the delivery person, information on how the delivery person is traveling (e.g., walking, biking, driving, riding transit, and/or the like), and/or any information on a planned route to the vending location (e.g., including any stops the delivery person will make on the way).

At block 1104, the process includes determining an estimated arrival time based on the geographic information. The estimated time of arrival can represent an estimated actual pick-up time for the order, which can be significantly after an order is received (e.g., and therefore significantly after an order will be completed if produced immediately). Determining the estimated arrival time can include generating a route between the location of the delivery person (or the customer) and the vending location based on various modes of travel, determining traffic information, estimating travel time on the route, and/or the like. Additionally, or alternatively, determining the estimated travel time can include referencing average travel times along the route between the delivery person (or customer) and the vending location.

At block 1106, the process 1100 includes determining an estimated reception time for the order to the customer based on the distance between the delivery location and the vending location and the estimated arrival time. Determining the estimated delivery time to the customer can include generating a route between the delivery location and the vending location based on various modes of travel, determining traffic information, estimating travel time on the route, and/or the like. Additionally, or alternatively, determining the estimated delivery time can include referencing average travel times along the route between the delivery location and the vending location. In embodiments where the order will be picked up at the vending location by the customer (e.g., not delivered), the reception time is generally equal to the estimated arrival time from block 1104 as calculated for the customer.

At block 1108, the process 1100 includes checking a queue of orders at the chosen robot for each beverage in the order. Similar to the discussion above, checking the queue at the chosen robot can include accessing a central, updated database (e.g., at the primary robot, at the remote system, and/or the like), querying another database for the queue (e.g., the POS system, onsite computing system, and/or the like), and/or querying the chosen robots for the most current queue.

At block 1110, the process 1100 includes estimating a time of completion for each beverage in the order (and/or the order overall) based on the queue information from block 1110. As discussed above, the estimated completion time can be based on an estimated preparation time for each of the beverages in the queue(s) plus an estimated preparation time for the beverage(s) in the order. In various embodiments, the estimated preparation time is based on an average preparation time per beverage, preparation times specific to the beverages in the queue(s), planned downtime at the beverage robot(s) (e.g., for maintenance, cleaning, ingredient replacement, and/or the like), and/or the like.

At block 1112, the process 1100 includes predicting changes to various beverage qualities between the estimated completion time from block 1110 and the estimated reception time from block 1106. The changes in beverage qualities can be based on dilution from melting ice, cooling from ambient air, evaporation, dispersion and/or settling between layers, and/or the like. For example, for an iced beverage, ice melt can dilute the beverage and thereby reduce a concentration of flavors in the beverage over time. In this example, the process 1100 at block 1112 can include determining an estimated water dilution to the beverage caused by the ice melting in the beverage between the completion time and the reception time and/or a temperature the beverage is stored in between the completion time and the reception time. To estimate the dilution, the process 1100 can select an ambient temperature (e.g., a current outside temperature), an average temperature in a vehicle, or a preselected temperature (e.g., 75° F.), and/or the like. The process 1100 can then calculate or estimate how much ice will melt per unit of time at the selected temperature. In a specific, non-limiting example, a single ice cube can melt in 90 minutes at 75° F. Accordingly, using the melt rate at the selected temperature and the time between the completion time and the reception time, the process 1100 can estimate the volume of water from melting ice that will dilute the beverage before the customer receives the beverage. In another example, for a hot beverage, the process 1100 can estimate how much water will evaporate from the beverage per unit of time. The process 1100 can use the evaporation rate and the time between the completion time and the reception time to estimate how much water will evaporate (thereby concentrating the beverage) before the customer receives the beverage.

At block 1114, the process 1100 includes adjusting the recipe of the beverage to account for the predicted changes in quality from block 1112. For example, the process 1100 can reduce the volume of water (and/or a ratio of water) in the recipe to account for dilution from the ice and/or increase a volume of ice added to the beverage to help ensure the drink maintains a quality level (e.g., temperature and dilution level) at the reception time. In a specific, non-limiting example, the recipe for a beverage can include 2 ounces of a first ingredient, 3 ounces of a second ingredient, 5 ounces of water; and 5 ounces of ice. Due to the estimated volume of melting ice during delivery, the process 1100 can adjust the recipe to 2 ounces of a first ingredient, 3 ounces of a second ingredient, 3 ounces of water, and 7 ounces of ice. Additionally, or alternatively, the process 1100 can increase a volume of the first and second ingredients added to the beverage. In another example, the process 1100 can increase a volume of water added to a hot beverage to account for evaporating water, increase a temperature of water added to the hot beverage to account for cooling over time, and/or the like. In yet another example, the process 1100 can modify an order by adding ingredients to the beverage to account for settling between layers in the beverage over time (e.g., adding particulate ingredients later to allow the particulates to settle into the beverage rather than settle at the bottom of the beverage).

In some embodiments, the process 1100 at block 1114 includes notifying one or more persons about the adjustments to the recipe. For example, the process 1100 at block 1114 can include displaying the alteration on a user interface of one or more of the beverage robots. The message can alert staff at the vending location about the adjustment, instruct the staff on modifications to the preparation (e.g., to adjust the ice amount added to a beverage), and/or the like. In another example, the process 1100 at block 1114 can include sending a notification to a user device associated with the order (e.g., a mobile device associated with the customer) regarding the adjustments. The notification can, for example, inform the customer regarding the adjustments, allow a customer to decline the adjustments, and/or the like.

At block 1116, the process 1100 can include preparing the beverage(s) in the order according to the adjusted recipes. The process 1100 at block 1116 can include sending (e.g., transmitting) the updated recipes and preparation instructions to beverage robots chosen to prepare the beverage(s) (e.g., chosen at block 818 of FIG. 8). As a result, the chosen robots will add the beverage(s) to their queue (or modify their queue) and prepare the beverage(s) according to the adjusted recipes. Additionally, the process 1100 at block 820 can include sending an indication of the updated recipe to any other suitable destination. For example, the process 1100 at block 1116 can include updating the central database to update the queue corresponding to the chosen robot. In another example, the process 1100 at block 1116 can include sending the updated recipe to the POS system, the onsite computing devices, and/or the remote system to update queues stored therein, update a status of the order visible to a customer associated with the order, and/or the like.

Although the blocks 1102-1116 of the process 1100 are discussed and illustrated in a particular order, the process 1100 illustrated in FIG. 11 is not so limited. For example, various steps of the process 1100 can be performed in a different order. In these and other embodiments, any of the blocks 1102-1116 of the process 1100 can be performed before, during, and/or after any of the other blocks 1102-1116 of the process 1100. In a specific, non-limiting example, all or a subset of the blocks 1108-1110 can be executed before executing the blocks 1102-1106 to estimate a completion time for the order before (or while) determining an estimated reception time for the user associated with the order. In another specific, non-limiting example, the process 1100 can omit block 1108 and/or block 1110 based on information received while executing any of the other processes disclosed herein. Moreover, a person of ordinary skill in the relevant art will recognize that the illustrated process 1100 can be altered and still remain within these and other embodiments of the present technology. For example, the process 1100 can be integrated into any of the processes discussed above with reference to FIGS. 8-10.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A method for operating a network having one or more beverage robots, the method comprising:
receiving an order requesting a beverage from the network, wherein the beverage is associated with a recipe requiring one or more ingredients;
assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
determining, based on the queue at the chosen beverage robot, an estimated completion of the order; and
transmitting an update about a status of the order, wherein the status includes data indicating the estimated completion of the order.

2. The method of example 1, further comprising:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

3. The method of any of examples 1-2, further comprising:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

4. The method of any of examples 1-3, further comprising:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

5. The method of any of examples 1-4, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

6. The method of any of examples 1-5, further comprising:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.

7. The method of any of examples 1-6, wherein the update is a first update, and wherein the method further comprises:
determining an availability of the one or more ingredients at the chosen beverage robot;
adjusting a placement of the order in the queue based on the availability of the one or more ingredients;
checking an updated status of the order at the chosen beverage robot, wherein checking the updated status comprises identifying a remaining queue at the chosen beverage robot ahead of the order and determining an updated estimated completion of the order based on the remaining queue;
transmitting a second update about the order, wherein the second update comprises information related to the remaining queue and the estimated completion of the order;
and receiving a response from a customer, the response indicating an approval to complete the order at the chosen beverage robot.

8. A system comprising:
one or more processors; and
one or more memories storing instructions that, when executed by the one or more processors, cause the system to perform a process for operating a network having one or more beverage robots, the process comprising:
   receiving an order requesting a beverage from the network, wherein the beverage is associated with a recipe requiring one or more ingredients;
   assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
   determining, based on the queue at the chosen beverage robot, an estimated completion of the order; and
   transmitting an update about a status of the order, wherein the status includes data indicating the estimated completion of the order.

9. The system of example 8, wherein the process further comprises:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

10. The system of any of examples 8-9, wherein the process further comprises:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

11. The system of any of examples 8-10, wherein the process further comprises:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

12. The system of any of examples 8-11, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

13. The system of any of examples 8-12, wherein the process further comprises:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.

14. The system of any of examples 8-13, wherein the update is a first update, and wherein the process further comprises:
determining an availability of the one or more ingredients at the chosen beverage robot;
adjusting a placement of the order in the queue based on the availability of the one or more ingredients;
checking an updated status of the order at the chosen beverage robot, wherein checking the updated status comprises identifying a remaining queue at the chosen beverage robot ahead of the order and determining an updated estimated completion of the order based on the remaining queue;
transmitting a second update about the order, wherein the second update comprises information related to the remaining queue and the estimated completion of the order; and
receiving a response from a customer, the response indicating an approval to complete the order at the chosen beverage robot.

15. A non-transitory computer-readable medium storing instructions that, when executed by a computing system, cause the computing system to perform operations for operating a network having one or more beverage robots, the operations comprising:
receiving an order requesting a beverage from the network, wherein the beverage is associated with a recipe requiring one or more ingredients;
assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
determining, based on the queue at the chosen beverage robot, an estimated completion of the order; and
transmitting an update about a status of the order, wherein the status includes data indicating the estimated completion of the order.

16. The non-transitory computer-readable medium of example 15, wherein the operations further comprise:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

17. The non-transitory computer-readable medium of any of examples 15-16, wherein the operations further comprise:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

18. The non-transitory computer-readable medium of any of examples 15-17, wherein the operations further comprise:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

19. The non-transitory computer-readable medium of any of examples 15-18, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

20. The non-transitory computer-readable medium of any of examples 15-19, wherein the operations further comprise:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.

### CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. In addition, the singular forms “a,” “an,” and “the” herein are intended to comprise the plural forms as well, unless the context clearly indicates otherwise. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Still further, the terms “approximately,” “generally,” and “about” are used herein to mean within at least within 10% of a given value or limit. Purely by way of example, an approximate ratio means within 10% of the given ratio.

Several embodiments of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A method for operating a network having one or more beverage robots, the method comprising:
receiving an order requesting a beverage from the network, wherein the beverage is associated with a recipe requiring one or more ingredients;
assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
determining, based on the queue at the chosen beverage robot, an estimated completion of the order; and
transmitting an update about a status of the order, wherein the status includes data indicating the estimated completion of the order.

2. The method of claim 1, further comprising:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

3. The method of claim 1, further comprising:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

4. The method of claim 1, further comprising:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

5. The method of claim 4, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

6. The method of claim 1, further comprising:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.

7. The method of claim 1, wherein the update is a first update, and wherein the method further comprises:
determining an availability of the one or more ingredients at the chosen beverage robot;
adjusting a placement of the order in the queue based on the availability of the one or more ingredients;
checking an updated status of the order at the chosen beverage robot, wherein checking the updated status comprises identifying a remaining queue at the chosen beverage robot ahead of the order and determining an updated estimated completion of the order based on the remaining queue;
transmitting a second update about the order, wherein the second update comprises information related to the remaining queue and the estimated completion of the order; and
receiving a response from a customer, the response indicating an approval to complete the order at the chosen beverage robot.

8. A system comprising:
one or more processors; and
one or more memories storing instructions that, when executed by the one or more processors, cause the system to perform a process for operating a network having one or more beverage robots, the process comprising:
receiving an order requesting a beverage from the network, wherein the beverage is associated with a recipe requiring one or more ingredients;
assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
determining, based on the queue at the chosen beverage robot, an estimated completion of the order; and
transmitting an update about a status of the order, wherein the status includes data indicating the estimated completion of the order.

9. The system of claim 8, wherein the process further comprises:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

10. The system of claim 8, wherein the process further comprises:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

11. The system of claim 8, wherein the process further comprises:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

12. The system of claim 11, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

13. The system of claim 8, wherein the process further comprises:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.

14. The system of claim 8, wherein the update is a first update, and wherein the process further comprises:
determining an availability of the one or more ingredients at the chosen beverage robot;
adjusting a placement of the order in the queue based on the availability of the one or more ingredients;
checking an updated status of the order at the chosen beverage robot, wherein checking the updated status comprises identifying a remaining queue at the chosen beverage robot ahead of the order and determining an updated estimated completion of the order based on the remaining queue;
transmitting a second update about the order, wherein the second update comprises information related to the remaining queue and the estimated completion of the order; and
receiving a response from a customer, the response indicating an approval to complete the order at the chosen beverage robot.

15. A non-transitory computer-readable medium storing instructions that, when executed by a computing system, cause the computing system to perform operations for operating a network having one or more beverage robots, the operations comprising:
receiving an order requesting a beverage from the network, wherein the beverage is associated with a recipe requiring one or more ingredients;
assigning the beverage to a chosen beverage robot from the one or more beverage robots, wherein assigning the beverage to the chosen beverage robot causes the order to be added to a queue at the chosen beverage robot, and wherein the queue is associated with beverages to be prepared by the chosen beverage robot;
determining, based on the queue at the chosen beverage robot, an estimated completion of the order; and
transmitting an update about a status of the order, wherein the status includes data indicating the estimated completion of the order.

16. The non-transitory computer-readable medium of claim 15, wherein the operations further comprise:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, adjusting a placement of the order in the queue to synchronize the estimated completion of the order with the estimated time of arrival.

17. The non-transitory computer-readable medium of claim 15, wherein the operations further comprise:
receiving, from a client computing device associated with the order, geographic information related to a current location of a customer;
determining, based on the geographic information, an estimated time of arrival of the customer at a vending location associated with the network; and
in response to a determination that the estimated time of arrival is more than a predetermined period after the estimated completion of the order, pausing production of the order until a predetermined time before the estimated time of arrival.

18. The non-transitory computer-readable medium of claim 15, wherein the operations further comprise:
determining a delivery location associated with the order based on information received with the order;
determining a reception time associated based on an estimated arrival time of a delivery person and a delivery time associated with traveling from a vending location associated with the network and to the delivery location; and
adjusting the recipe based on a difference between the estimated completion of the order and the reception time.

19. The non-transitory computer-readable medium of claim 18, wherein adjusting the recipe includes:
estimating a volume of water from melting ice between the estimated completion of the order and the reception time, wherein the volume from melting ice will dilute the beverage; and
adjusting an amount of water in the recipe to account for the volume of water from melting ice.

20. The non-transitory computer-readable medium of claim 15, wherein the operations further comprise:
receiving, from a client computing device associated with the order, geographic information related to a current location of a customer;
determining, based on the geographic information, an estimated time of arrival of the customer at a vending location associated with the network; and
adjusting a ratio of the one or more ingredients in the recipe based on a difference between the estimated completion of the order and the estimated time of arrival.
